(19) United States
(12) Patent Application Publication
(10) Pub. No.: US 2022/0334355 A1
(43) Pub. Date: Oct. 20, 2022

(54) Optical Imaging System

(71) Applicant: ZHEJIANG SUNNY OPTICS CO.,LTD., Ningbo (CN)

(72) Inventors: Wenchao ZHAO, Ningbo (CN); Yabin HU, Ningbo (CN); Jianke WENREN, Ningbo (CN); Fujian DAI, Ningbo (CN); Liefeng ZHAO, Ningbo (CN)

(21) Appl. No.: 17/718,353

(22) Filed: Apr. 12, 2022

(30) Foreign Application Priority Data
Apr. 13, 2021 (CN) 202110393836.2

(51) Int. Cl. G02B 9/64; G02B 13/00

(52) U.S. Cl. CPC G02B 9/64; G02B 13/0045

(57) ABSTRACT

The disclosure discloses an optical imaging system, which sequentially includes from an object side to an image side along an optical axis: a diaphragm; a first lens with a positive refractive power; a second lens with a refractive power; a third lens with a refractive power; a fourth lens with a refractive power; a fifth lens with a refractive power; a sixth lens with a refractive power, an object-side surface thereof is a convex surface; and a seventh lens with a positive refractive power, wherein an effective focal length f of the optical imaging system and an entrance pupil diameter (EPD) of the optical imaging system satisfy: f/EPD<1.3; and TTL is an on-axis distance from an object-side surface of the first lens to an imaging surface, Semi-FOV is a half of a maximum field of view of the optical imaging system, and TTL and Semi-FOV satisfy: 3.0 mm<TTL×Tan(Semi-FOV)<4.0 mm.

### CROSS-REFERENCE TO RELATED PRESENT INVENTION(S)

The disclosure claims priority to and the benefit of Chinese Patent Present invention No. 202110393836.2, filed in the China National Intellectual Property Administration (CNIPA) on 13 Apr. 2021, which is incorporated herein by reference in its entirety.

### TECHNICAL FIELD

The disclosure relates to the technical field of the optical imaging, and particularly relates to an imaging system including seven lenses.

### BACKGROUND

Optical imaging module is undoubtedly a revolutionary innovation on smart phones, and becomes an indispensable standard configuration of smart phones at present. Taking pictures with phones anytime anywhere during use of smart phones has become a fashion trend, and greatly enriches people's material and spiritual life. Optical imaging module is an important carrier of this trend. As people make further requirements on smart phones, optical imaging module has been constantly upgraded from original taking clear pictures to current taking nice pictures and then to randomly taking blockbusters in the future. In daily shooting, portrait photography is a vitally important application scene. A portrait lens with a large aperture and a small depth of field may undoubtedly implement high-definition local close-up of a portrait and good background defocusing to enable a consumer to take a blockbuster randomly, and thus has broad application prospect.

Based on this, there is a need for a compact optical imaging system with a large depth of focus and a characteristic of large aperture and capable of achieving small-depth-of-field characteristics of a prominent portrait, a blurred background and the like relatively well to satisfy requirements of portrait photography. In addition, the characteristic of large aperture ensures that enough beams penetrate through the optical imaging system, so the optical imaging system has relatively high low-light imaging quality, and may be complemented well with other camera modules.

### SUMMARY

The disclosure is intended to provide an optical imaging system including seven lenses. The optical imaging system has a large depth of focus and a characteristic of a large aperture, and may achieve small-depth-of-field characteristics of a prominent portrait, a blurred background and the like relatively well to satisfy requirements of portrait photography. The characteristic of large aperture ensures that enough beams penetrate through the optical imaging system, so the optical imaging system has relatively high low-light imaging quality, and may be complemented well with other camera modules.

An embodiment of the disclosure provides an optical imaging system, which sequentially includes from an object side to an image side along an optical axis: a diaphragm; a first lens with a positive refractive power; a second lens with a refractive power; a third lens with a refractive power; a fourth lens with a refractive power; a fifth lens with a refractive power; a sixth lens with a refractive power, an object-side surface thereof is a convex surface or a concave surface; and a seventh lens with a positive refractive power;

wherein an effective focal length f of the optical imaging system and an entrance pupil diameter (EPD) of the optical imaging system satisfy: f/EPD<1.3.

In an implementation mode, an effective focal length f1 of the first lens, a curvature radius R2 of an image-side surface of the first lens and the effective focal length f of the optical imaging system satisfy: 1.0<(f1+|R2|)/f<3.0.

In an implementation mode, an effective focal length f3 of the third lens and the effective focal length f of the optical imaging system satisfy: −1.0<f3/f<0.

In an implementation mode, an effective focal length f6 of the sixth lens and a curvature radius R12 of an image-side surface of the sixth lens satisfy: −5.0<f6/R12<−1.0.

In an implementation mode, an effective focal length f4 of the fourth lens and an effective focal length f5 of the fifth lens satisfy: 0<|f4/f5|<9.0.

In an implementation mode, a curvature radius R5 of an object-side surface of the third lens and a curvature radius R6 of an image-side surface of the third lens satisfy: 1.0<R5/R6<2.5.

In an implementation mode, a curvature radius R9 of an object-side surface of the fifth lens and a curvature radius R14 of an image-side surface of the seventh lens satisfy: 1.0<R9/R14<5.0.

In an implementation mode, a curvature radius R11 of the object-side surface of the sixth lens and a curvature radius R7 of an object-side surface of the fourth lens satisfy: 1.0<|R11/R7|<5.5.

In an implementation mode, a center thickness CT2 of the second lens on the optical axis and a center thickness CT3 of the third lens on the optical axis satisfy: 4.0<CT2/CT3<7.5.

In an implementation mode, T45 is an air space between the fourth lens and the fifth lens on the optical axis, and T45 and a center thickness CT4 of the fourth lens on the optical axis satisfy: 3.0<T45/CT4<8.0.

In an implementation mode, a center thickness CT3 of the third lens on the optical axis and a center thickness CT6 of the sixth lens on the optical axis satisfy: 4.5 mm⁻²<1/(CT3×CT6)<13.5 m⁻².

In an implementation mode, TTL is an on-axis distance from an object-side surface of the first lens to an imaging surface, Semi-FOV is a half of a maximum field of view of the optical imaging system, and TTL and Semi-FOV satisfy: 3.0 mm<TTL×Tan(Semi-FOV)<4.0 mm.

In an implementation mode, a refractive index N7 of the seventh lens satisfies: N7>1.6.

Another embodiment of the disclosure provides an optical imaging system, which sequentially includes from an object side to an image side along an optical axis: a diaphragm; a first lens with a positive refractive power; a second lens with a refractive power; a third lens with a refractive power; a fourth lens with a refractive power; a fifth lens with a refractive power; a sixth lens with a refractive power, an object-side surface thereof is a convex surface or a concave surface; and a seventh lens with a positive refractive power.

The lenses are independent of each another. There are air spaces between each of the lenses on the optical axis. TTL is an on-axis distance from an object-side surface of the first lens to an imaging surface, Semi-FOV is a half of a maximum field of view of the optical imaging system, and TTL and Semi-FOV satisfy: 3.0 mm<TTL×Tan(Semi-FOV)<4.0 mm.

The disclosure has the following beneficial effects.

The optical imaging system provided in the disclosure includes multiple lenses, e.g., the first lens to the seventh lens. The optical imaging system of the disclosure has a large depth of focus and the characteristic of large aperture, and may achieve the small-depth-of-field characteristics of portrait focusing, background defocusing and the like relatively well to satisfy requirements of portrait photography. The characteristic of large aperture ensures that enough beams penetrate through the optical imaging system, so the optical imaging system has relatively high low-light imaging quality, and may be complemented well with other camera modules.

### BRIEF DESCRIPTION OF THE DRAWINGS

In order to describe the technical solutions in the embodiments of the disclosure more clearly, the drawings required to be used for describing the embodiments will be simply introduced below. It is apparent that the drawings described below are only some embodiments of the disclosure. Those of ordinary skill in the art may further obtain other drawings according to these drawings without creative work.

FIG. 1 shows a structural schematic diagram of a lens group of an optical imaging system according to Embodiment 1 of the disclosure;

FIGS. 2a-2d show a longitudinal aberration curve, an astigmatism curve, a distortion curve and a lateral color curve of an optical imaging system according to Embodiment 1 of the disclosure respectively;

FIG. 3 shows a structural schematic diagram of a lens group of an optical imaging system according to Embodiment 2 of the disclosure;

FIGS. 4a-4d show a longitudinal aberration curve, an astigmatism curve, a distortion curve and a lateral color curve of an optical imaging system according to Embodiment 2 of the disclosure respectively;

FIG. 5 shows a structural schematic diagram of a lens group of an optical imaging system according to Embodiment 3 of the disclosure;

FIGS. 6a-6d show a longitudinal aberration curve, an astigmatism curve, a distortion curve and a lateral color curve of an optical imaging system according to Embodiment 3 of the disclosure respectively;

FIG. 7 shows a structural schematic diagram of a lens group of an optical imaging system according to Embodiment 4 of the disclosure;

FIGS. 8a-8d show a longitudinal aberration curve, an astigmatism curve, a distortion curve and a lateral color curve of an optical imaging system according to Embodiment 4 of the disclosure respectively;

FIG. 9 shows a structural schematic diagram of a lens group of an optical imaging system according to Embodiment 5 of the disclosure;

FIGS. 10a-10d show a longitudinal aberration curve, an astigmatism curve, a distortion curve and a lateral color curve of an optical imaging system according to Embodiment 5 of the disclosure respectively;

FIG. 11 shows a structural schematic diagram of a lens group of an optical imaging system according to Embodiment 6 of the disclosure; and

FIGS. 12a-12d show a longitudinal aberration curve, an astigmatism curve, a distortion curve and a lateral color curve of an optical imaging system according to Embodiment 6 of the disclosure respectively.

### DETAILED DESCRIPTION OF THE EMBODIMENTS

The technical solutions in embodiments of the disclosure will be described clearly and completely below in combination with the drawings in the embodiments of the disclosure. It is apparent that the described embodiments are not all but only part of embodiments of the disclosure. All other embodiments obtained by those of ordinary skill in the art based on the embodiments in the disclosure without creative work shall fall within the scope of protection of the disclosure.

It should be noted that, in this description, expressions first, second, third and the like are only used to distinguish one feature from another feature and do not represent any limitation to the feature. Thus, a first lens discussed below may also be referred to as a second lens or a third lens without departing from the teachings of the disclosure.

It should also be understood that terms “include”, “including”, “have”, “contain”, and/or “containing”, used in the specification, represent existence of a stated feature, component and/or part but do not exclude existence or addition of one or more other features, components and parts and/or combinations thereof. In addition, expressions like “at least one in . . . ” may appear after a list of listed features not to modify an individual component in the list but to modify the listed features. Moreover, when the implementation modes of the disclosure are described, “may” is used to represent “one or more implementation modes of the disclosure”. Furthermore, term “exemplary” refers to an example or exemplary description.

In the drawings, the thickness, size and shape of the lens have been slightly exaggerated for ease illustration. In particular, a spherical shape or aspheric shape shown in the drawings is shown by some embodiments. That is, the spherical shape or the aspheric shape is not limited to the spherical shape or aspheric shape shown in the drawings. The drawings are by way of example only and not strictly to scale.

In the description of the disclosure, a paraxial region refers to a region nearby an optical axis. If a surface of a lens is a convex surface and a position of the convex surface is not defined, it indicates that at least a paraxial region of the surface of the lens is a convex surface. If a surface of a lens is a concave surface and a position of the concave surface is not defined, it indicates that at least a paraxial region of the surface of the lens is a concave surface. A surface, closest to a shot object, of each lens is called an object-side surface of the lens, and a surface, closest to an imaging surface, of each lens is called an image-side surface of the lens.

Unless otherwise defined, all terms (including technical terms and scientific terms) used in the disclosure have the same meanings as commonly understood by those of ordinary skill in the art of the disclosure. It should also be understood that the terms (for example, terms defined in a common dictionary) should be explained to have meanings consistent with the meanings in the context of a related art and may not be explained with ideal or excessively formal meanings, unless clearly defined like this in the disclosure.

It is to be noted that the embodiments in the disclosure and features in the embodiments may be combined without conflicts. The features, principles and other aspects of the disclosure will be described in detail below with reference to the drawings and in combination with embodiments.

### EXEMPLARY EMBODIMENTS

An optical imaging system of the exemplary embodiment of the disclosure includes seven lenses, sequentially including from an object side to an image side along an optical axis: a diaphragm, a first lens, a second lens, a third lens, a fourth lens, a fifth lens, a sixth lens, and a seventh lens. The lenses are independent of each another. There are air spaces between each of the lenses on the optical axis.

In an exemplary embodiment, the first lens has a positive refractive power; the second lens may have a positive refractive power or a negative refractive power; the third lens may have a positive refractive power or a negative refractive power; the fourth lens may have a positive refractive power or a negative refractive power; the fifth lens may have a positive refractive power or a negative refractive power; the sixth lens may have a positive refractive power or a negative refractive power, and an object-side surface thereof is a convex surface or a concave surface; and the seventh lens has a positive refractive power.

In an exemplary embodiment, an effective focal length f of the optical imaging system and an entrance pupil diameter (EPD) of the optical imaging system satisfy a conditional expression: f/EPD<1.3. A ratio of the effective focal length to the entrance pupil diameter of the optical imaging system is controlled, so that a characteristic of wide angle of the optical imaging system may be optimized, and meanwhile, the lens may obtain a sufficient illumination intensity to ensure enough beams arriving at an image surface to optimize the imaging quality at dusk or under relatively low light. More specifically, f and EPD satisfy: 1<f/EPD<1.25, e.g., 1.18≤f/EPD≤1.23.

In an exemplary embodiment, an effective focal length f1 of the first lens, a curvature radius R2 of an image-side surface of the first lens and the effective focal length f of the optical imaging system satisfy a conditional expression: 1.0<(f1+|R2|)/f<3.0. A ratio of the sum of the focal length of the first lens and the curvature radius of the image-side surface of the first lens to the effective focal length of the optical imaging system may be controlled to control magnitudes of a curvature radius and refractive power of the first lens effectively, thereby reducing a sensitivity of the lens and avoiding overstrict tolerance requirements. In addition, controlling this value may be matched with the whole optical imaging system by cross distribution to balance positive and negative spherical aberrations, lateral colors and the like in different fields of view better, thereby improving the resolving power of the whole optical imaging system. More specifically, f1, R2 and f satisfy: 1.1<(f1+|R2|)/f<2.8, e.g., 1.18≤(f1+|R2|)/f≤2.79.

In an exemplary embodiment, an effective focal length f3 of the third lens and the effective focal length f of the optical imaging system satisfy a conditional expression: −1.043/f<0. The effective focal length of the third lens is configured reasonably, so that a sensitivity of the lens may be reduced effectively, overstrict tolerance requirements may be avoided, and a spherical aberration, chromatic aberration and astigmatism generated by the third lens may be balanced. More specifically, f3 and f satisfy: −0.8<f3/f<−0.6, e.g., −0.75≤f3/f≤−0.64.

In an exemplary embodiment, an effective focal length f6 of the sixth lens and a curvature radius R12 of an image-side surface of the sixth lens satisfy a conditional expression: −5.0<f6/R12<−1.0. The curvature radius of the image-side surface of the sixth lens is configured reasonably, so that the condition that the curvature radius of the optical surface of the image-side surface of the sixth lens is out of tolerance is avoided, and a vector height of the lens is controlled within a reasonable range. Therefore, a deflection of light in the sixth lens may be reduced, a sensitivity of the lens is reduced effectively, and meanwhile, a convergence of light is facilitated to avoid total reflection on the surface of the lens and the generation of a ghost. More specifically, f6 and R12 satisfy: −4.946/R12<−1.3, e.g., −4.80≤f6/R12≤−1.37.

In an exemplary embodiment, an effective focal length f4 of the fourth lens and an effective focal length f5 of the fifth lens satisfy a conditional expression: 0<|f4/f5|<9.0. Effective focal length values of the fourth and fifth lenses are configured reasonably, so that problems of distortion, astigmatism and the like of the whole optical imaging system may be balanced better. In addition, the ratio may be controlled to obtain a larger image surface, and a larger imaging surface is matched to achieve higher imaging quality. More specifically, f4 and f5 satisfy: 1.3<|f4/f5|<8.8, e.g., 1.32≤|f4/f5|≤8.78.

In an exemplary embodiment, a curvature radius R5 of an object-side surface of the third lens and a curvature radius R6 of an image-side surface of the third lens satisfy a conditional expression: 1.0<R5/R6<2.5. Numerical values of the curvature radii of the object-side surface and the image-side surface of the third lens are controlled reasonably, so that it may be ensured that light penetrating through the third lens is converged relatively well, a deflection angle of light may be reduced, and a sensitivity is reduced. A relatively high luminous flux of the lens is ensured, and an overlarge inclination angle of a surface type of the lens caused by steep light is avoided, thereby avoiding process problems in practical machine-forming. More specifically, R5 and R6 satisfy: 2<R5/R6<2.4, e.g., 2.07≤R5/R6≤2.36.

In an exemplary embodiment, a curvature radius R9 of an object-side surface of the fifth lens and a curvature radius R14 of an image-side surface of the seventh lens satisfy a conditional expression: 1.0<R9/R14<5.0. A ratio of the curvature radii of the object-side surface of the fifth lens and the image-side surface of the seventh lens is controlled reasonably, so that machining difficulties brought by overlarge inclination angles of the lens surfaces may be avoided, meanwhile, a process sensitivity of the fifth lens may be reduced, overstrict tolerance limits and demanding machining procedures are avoided, and a coma, field curvature and the like of the lens are buffered effectively. More specifically, R9 and R14 satisfy: 1.0<R9/R14<4.6, e.g., 1.03≤R9/R14≤4.50.

In an exemplary embodiment, a curvature radius R11 of the object-side surface of the sixth lens and a curvature radius R7 of an object-side surface of the fourth lens satisfy a conditional expression: 1.0<|R11/R7|<5.5. A ratio of the curvature radii of the object-side surface of the fourth lens and the object-side surface of the sixth lens is controlled reasonably, so that machining difficulties brought by overlarge inclination angles of the lens surfaces may be avoided, meanwhile, a process sensitivity of the fifth lens may be reduced, and the third lens of the optical imaging system may be matched to ensure better convergence of external light to balance a spherical aberration and field curvature of the optical imaging system effectively. More specifically, R11 and R7 satisfy: 1.1<|R11/R7|<5.2, e.g., 1.16≤|R11/R7|≤5.12.

In an exemplary embodiment, a center thickness CT2 of the second lens on the optical axis and a center thickness CT3 of the third lens on the optical axis satisfy a conditional expression: 4.0 mm⁻²<(CT2×CT3)<7.5 mm⁻². A range of a ratio of the center thickness of the second lens to the center thickness of the third lens is configured reasonably, so that thicknesses of the two lenses may be combined in order, and such a combination mode balances positive and negative spherical aberrations, positive and negative astigmatisms, positive and negative distortions, longitudinal aberrations and the like to a certain extent, achieves a good complementary buffer effect on performance in different temperature environments, and achieves a relatively good temperature drift performance. More specifically, CT2 and CT3 satisfy: 4.3 mm⁻²<(CT2×CT3)<6 mm⁻², e.g., 4.32 mm⁻²≤(CT2×CT3)≤5.72 mm⁻².

In an exemplary embodiment, T45 is an air space between the fourth lens and the fifth lens on the optical axis and T45 and a center thickness CT4 of the fourth lens on the optical axis satisfy a conditional expression: 3.0<T45/CT4<8.0. The center thickness of the fourth lens on the optical axis and the air space between the fourth lens and the fifth lens on the optical axis are adjusted reasonably, and a range of a ratio of the two is controlled cooperatively, so that a distortion of the optical imaging system may be balanced better.

The cooperative control may reduce ghost energy between the fourth lens and the fifth lens appropriately and ensure relatively high imaging quality of the optical imaging system. More specifically, T45 and CT4 satisfy: 3.2<T45/CT4<5, e.g., 3.26≤T45/CT4≤4.39.

In an exemplary embodiment, a center thickness CT3 of the third lens on the optical axis and a center thickness CT6 of the sixth lens on the optical axis satisfy a conditional expression: 4.5<1/CT3/CT6<13.5. The center thicknesses of the third lens and the sixth lens on the optical axis are combined reasonably and constrained cooperatively in form of product reciprocal, so that machining difficulties brought by too small center thicknesses of the lenses may be avoided, the fourth lens of the optical imaging system is matched to reduce a coma of the optical imaging system effectively, and meanwhile, ghosts and a Modulation Transfer Function (MTF) design value are improved well. More specifically, CT3 and CT6 satisfy: 4.9<1/CT3/CT6<13.5, e.g., 4.95≤1/CT3/CT6≤13.49.

In an exemplary embodiment, TTL is an on-axis distance from an object-side surface of the first lens to an imaging surface, Semi-FOV is a half of a maximum field of view of the optical imaging system, and TTL and Semi-FOV satisfy a conditional expression: 3.0 mm<TTL×Tan(Semi-FOV)<4.0 mm. A product of a total length dimension of the optical imaging system and the maximum field of view of the optical imaging system is controlled to satisfy the above constraint condition, so that the maximum field of view of the lens may be enlarged maximally to obtain object surface information in a larger angle range on the premise of ensuring a smaller size of the optical imaging system. This value may be controlled to make the optical imaging system small and portable, and the compact structure is favorable for torsional force, high-altitude falling and drum tests and more extensive application. More specifically, TTL and Semi-FOV satisfy: 3.2 mm<TTL×Tan(Semi-FOV)<3.9 mm, e.g., 3.25 mm≤TTL×Tan(Semi-FOV)≤3.81 mm.

In an exemplary embodiment, N7 is a refractive index of the seventh lens, and N7 satisfies a conditional expression: N7>1.6. More specifically, N7 satisfies: N7>1.65, e.g., N7=1.68.

In an exemplary embodiment, the optical imaging system may further include a diaphragm. The diaphragm may be arranged at an appropriate position as required. For example, the diaphragm may be arranged between the object side and the first lens. In an embodiment, the optical imaging system may further include an optical filter configured to correct a chromatic aberration and/or a protective glass configured to protect a photosensitive element on the imaging surface.

The optical imaging system according to the embodiment of the disclosure may adopt multiple lenses, for example, the above-mentioned seven. The refractive powers and surface types of each lens, the center thickness of each lens, on-axis distances between the lenses and the like are configured reasonably to endow the optical imaging system with a relatively large imaging surface and the characteristics of wide imaging range and high imaging quality and ensure an ultra-thin design of a mobile phone.

In an exemplary embodiment, at least one of mirror surfaces of each lens is an aspheric mirror surface. That is, at least one mirror surface in the object-side surface of the first lens to the image-side surface of the seventh lens is an aspheric mirror surface. An aspheric lens has such a characteristic that a curvature keeps changing from a center of the lens to a periphery of the lens. Unlike a spherical lens with a constant curvature from a center of the lens to a periphery of the lens, the aspheric lens has a better curvature radius characteristic and the advantages of improving distortions and improving astigmatism aberrations. With the adoption of the aspheric lens, astigmatic aberrations during imaging may be eliminated as much as possible, thereby improving the imaging quality. In an embodiment, at least one of the object-side surface and image-side surface of each lens in the first lens, the second lens, the third lens, the fourth lens, the fifth lens, the sixth lens and the seventh lens is an aspheric mirror surface. In another embodiment, both the object-side surface and the image-side surface of each lens in the first lens, the second lens, the third lens, the fourth lens, the fifth lens, the sixth lens and the seventh lens are aspheric mirror surfaces.

However, those skilled in the art should know that the number of the lenses forming the optical imaging system may be changed without departing from the technical solutions claimed in the disclosure to achieve each result and advantage described in the specification. For example, although descriptions are made in the implementation mode with seven lenses as an example, the optical imaging system is not limited to seven lenses. If necessary, the optical imaging system may include another number of lenses.

Specific embodiments applicable to the optical imaging system of the above-mentioned embodiment will further be described below with reference to the drawings.

### Embodiment 1

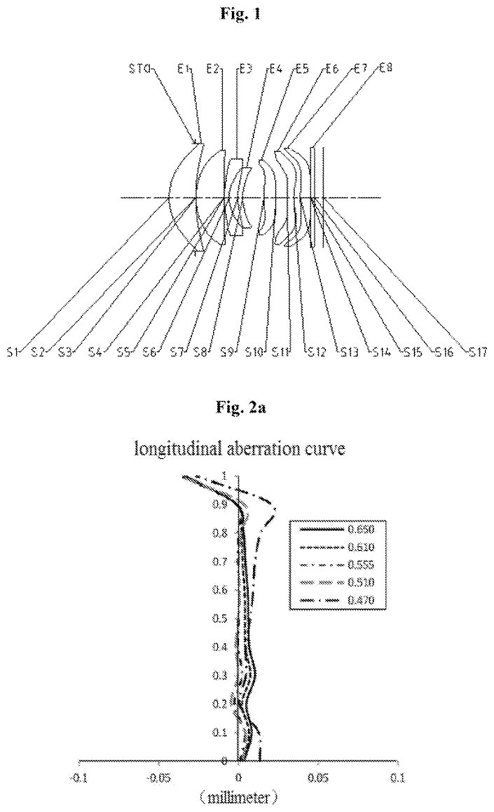

FIG. 1 is a structural schematic diagram of a lens group of an optical imaging system according to Embodiment 1 of the disclosure. The optical imaging system sequentially includes from an object side to an image side along an optical axis: a diaphragm STO, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, and an image-side surface S2 thereof is a concave surface. The second lens E2 has a positive refractive power, an object-side surface S3 thereof is a convex surface, and an image-side surface S4 thereof is a convex surface. The third lens E3 has a negative refractive power, an object-side surface S5 thereof is a convex surface, and an image-side surface S6 thereof is a concave surface. The fourth lens E4 has a negative refractive power, an object-side surface S7 thereof is a convex surface, and an image-side surface S8 thereof is a concave surface. The fifth lens E5 has a positive refractive power, an object-side surface S9 thereof is a convex surface, and an image-side surface S10 thereof is a concave surface. The sixth lens E6 has a negative refractive power, an object-side surface S11 thereof is a convex surface, and an image-side surface S12 thereof is a concave surface. The seventh lens E7 has a positive refractive power, an object-side surface S13 thereof is a convex surface, and an image-side surface S14 thereof is a concave surface. The optical filter E8 has an object-side surface S15 and an image-side surface S16. Light from an object sequentially penetrates through each of the surfaces S1 to S16, and is finally imaged on the imaging surface S17.

Table 1 shows a basic parameter table of the optical imaging system of Embodiment 1, wherein units of the curvature radius, the thickness and the focal length are all millimeters (mm).

TABLE 1

| Surface | Surface | Curvature | Thickness/ | Focal | Refractive | Abbe | Conic |
|---|---|---|---|---|---|---|---|
| number | type | radius | distance | length | index | number | coefficient |
| OBJ | Spherical | Infinite | Infinite | | | | |
| STO | Spherical | Infinite | −1.6000 | | | | |
| S1 | Aspheric | 3.9356 | 1.6464 | 9.52 | 1.55 | 56.0 | 0.0000 |
| S2 | Aspheric | 13.8714 | 0.0200 | | | | 0.0000 |
| S3 | Aspheric | 4.9262 | 1.7150 | 8.12 | 1.55 | 56.0 | 0.0000 |
| S4 | Aspheric | −38.4341 | 0.0200 | | | | 36.5801 |
| S5 | Aspheric | 5.1849 | 0.3000 | −5.87 | 1.68 | 19.2 | 0.0000 |
| S6 | Aspheric | 2.1965 | 0.5478 | | | | 0.0000 |
| S7 | Aspheric | 3.7958 | 0.3000 | −26.22 | 1.68 | 19.2 | 0.0000 |
| S8 | Aspheric | 3.0274 | 1.3174 | | | | 0.0000 |
| S9 | Aspheric | 10.6348 | 0.7321 | 15.76 | 1.68 | 19.2 | 0.0000 |
| S10 | Aspheric | 2985.7615 | 0.6884 | | | | 0.0000 |
| S11 | Aspheric | 4.3989 | 0.4000 | −12.36 | 1.55 | 56.0 | 0.0000 |
| S12 | Aspheric | 2.5760 | 0.4173 | | | | −1.0000 |
| S13 | Aspheric | 10.3307 | 0.6293 | 617.95 | 1.68 | 19.2 | 0.0000 |
| S14 | Aspheric | 10.3318 | 0.0365 | | | | 0.0000 |
| S15 | Spherical | Infinite | 0.2100 | | 1.52 | 64.2 | |
| S16 | Spherical | Infinite | 0.5397 | | | | |
| S17 | Spherical | Infinite | | | | | |

As shown in Table 2, in Embodiment 1, f is a total effective focal length of the optical imaging system, and f is 8.90 mm. TTL is a distance from the object-side surface S1 of the first lens E1 to the imaging surface S17 on the optical axis, and TTL is 9.52 mm. ImgH is a half of a diagonal length of an effective pixel region on the imaging surface S17, and ImgH is 3.39 mm. Semi-FOV is a half of a maximum field of view of the optical imaging system, and Semi-FOV is 20.6°.

TABLE 2
Embodiment 1

| | | | |
|---|---|---|---|
| f(mm) | 8.90 | TTL(mm) | 9.52 |
| ImgH(mm) | 3.39 | Semi-FOV(°) | 20.6 |
| f/EPD | 1.23 | (f1 + \|R2\|)/f | 2.63 |
| f3/r | −0.66 | f6/R12 | −4.80 |
| \|f4/f5\| | 1.66 | R5/R6 | 2.36 |
| R9/R14 | 1.03 | \|R11/R7\| | 1.16 |
| CT2/CT3 | 5.72 | T45/CT4 | 4.39 |
| 1/(CT3 × CT6)(mm⁻²) | 8.33 | TTL × T an(Semi-FOV)(mm) | 3.58 |

The optical imaging system in Embodiment 1 satisfies:

f/EPD=1.23, wherein f is an effective focal length of the optical imaging system, and EPD is an entrance pupil diameter of the optical imaging system;

(f1+|R2|)/f=2.63, wherein f1 is an effective focal length of the first lens, R2 is a curvature radius of the image-side surface of the first lens, and f is the effective focal length of the optical imaging system;

f3/f=−0.66, wherein f3 is an effective focal length of the third lens, and f is the effective focal length of the optical imaging system;

f6/R12=−4.80, wherein f6 is an effective focal length of the sixth lens, and R12 is a curvature radius of the image-side surface of the sixth lens;

|f4/f5|=1.66, wherein f4 is an effective focal length of the fourth lens, and f5 is an effective focal length of the fifth lens;

R5/R6=2.36, wherein R5 is a curvature radius of the object-side surface of the third lens, and R6 is a curvature radius of the image-side surface of the third lens;

R9/R14=1.03, wherein R9 is a curvature radius of the object-side surface of the fifth lens, and R14 is a curvature radius of the image-side surface of the seventh lens;

|R11/R7|=1.16, wherein R11 is a curvature radius of the object-side surface of the sixth lens, and R7 is a curvature radius of the object-side surface of the fourth lens;

CT2/CT3=5.72, where CT2 is a center thickness of the second lens on the optical axis, and CT3 is a center thickness of the third lens on the optical axis;

T45/CT4=4.39, wherein T45 is an air space between the fourth lens and the fifth lens on the optical axis, and CT4 is a center thickness of the fourth lens on the optical axis;

1/(CT3×CT6)=8.33 mm⁻², wherein CT3 is the center thickness of the third lens on the optical axis, and CT6 is a center thickness of the sixth lens on the optical axis;

TTL×Tan(Semi-FOV)=3.58 mm, wherein TTL is the on-axis distance from the object-side surface of the first lens to the imaging surface. Semi-FOV is the half of the maximum field of view of the optical imaging system; and

N7=1.68, wherein N7 is a refractive index of the seventh lens.

In Embodiment 1, both the object-side surface and the image-side surface of any lens in the first lens E1 to the seventh lens E7 are aspheric surfaces. A surface type x of each aspheric lens may be defined through, but not limited to, the following aspheric surface formula:

$$x = \frac{{ch}^{2}}{1 + \sqrt{1 - ( k + 1 ) {c}^{2} {h}^{2}}} + \sum {Aih}^{i} , \qquad ( 1 )$$

wherein x is a vector height of a distance between the aspheric surface and a vertex of the aspheric surface when the aspheric surface is located at a position with the height h in the optical axis direction; c is a paraxial curvature of the aspheric surface, c=1/R (namely, the paraxial curvature c is a reciprocal of the curvature radius R in Table 1); k is a conic coefficient; and Ai is a correction coefficient of the i-th order of the aspheric surface.

In Embodiment 1, both the object-side surface and the image-side surface of any lens in the first lens E1 to the seventh lens E7 are aspheric surfaces. Table 3 shows high-order coefficients A4, A6, A8, A10, A12, A14, A16, A18, A20, A22, A24, A26, A28 and A30 that may be used for each of the aspheric mirror surfaces S1 to S14 in Embodiment 1.

TABLE 3

| Surface | | | | | | | |
|---|---|---|---|---|---|---|---|
| number | A4 | A6 | A8 | A10 | A12 | A14 | A16 |
| S1 | −4.1057E−01 | −1.1595E−01 | −2.5811E−02 | −3.8993E−03 | −2.7391E−04 | 9.3258E−06 | 1.4330E−05 |
| S2 | 4.5569E−02 | −3.2400E−02 | 1.2843E−02 | −6.9789E−04 | 1.0392E−03 | 2.9093E−04 | −1.6747E−04 |
| S3 | 3.0116E−01 | 3.0837E−02 | 9.0428E−03 | −5.6955E−03 | −4.1260E−03 | −2.2053E−03 | −1.5003E−03 |
| S4 | 2.3606E−01 | −4.3959E−02 | 6.6576E−03 | −8.0481E−03 | 3.6173E−03 | −3.3492E−03 | 1.8244E−03 |
| S5 | −3.5994E−01 | 7.1886E−02 | −3.9215E−04 | −2.8310E−03 | 3.7466E−03 | −2.4684E−03 | 1.2843E−03 |
| S6 | −4.8694E−01 | −1.5449E−02 | −5.9960E−03 | −1.1115E−03 | 9.2292E−04 | −8.6327E−05 | −8.8225E−05 |
| S7 | −3.0306E−01 | 1.4837E−02 | 4.6031E−03 | 9.3053E−04 | −5.6702E−05 | −5.2204E−05 | −1.6653E−04 |
| S8 | −2.0010E−01 | 3.5310E−02 | 5.5097E−03 | 1.3479E−03 | 1.6332E−05 | 2.5627E−05 | −5.7216E−05 |
| S9 | −4.9247E−01 | −5.7310E−02 | 9.3916E−04 | 7.6294E−03 | 4.7517E−03 | 1.7467E−03 | 3.8495E−05 |
| S10 | −7.3374E−01 | −2.0461E−02 | 1.0443E−02 | 1.3820E−02 | 6.6653E−03 | 1.9631E−03 | −6.6469E−04 |
| S11 | −2.3669E+00 | 5.6521E−01 | −7.0389E−02 | 3.3275E−03 | −4.4873E−03 | −3.6775E−03 | 1.5263E−03 |
| S12 | −3.0271E+00 | 3.9461E−01 | −5.7110E−02 | 2.3926E−02 | −3.3404E−03 | 3.8215E−03 | −2.1299E−03 |
| S13 | −1.5182E+00 | −3.6087E−02 | 2.7147E−02 | 4.3343E−02 | 3.9304E−03 | 2.2082E−02 | 9.2147E−04 |
| S14 | −1.8386E+00 | 3.4041E−02 | −5.5147E−02 | 4.5559E−02 | −9.2604E−03 | 1.8173E−02 | 5.0467E−03 |
| Surface | | | | | | | |
| number | A18 | A20 | A22 | A24 | A26 | A28 | A30 |
| S1 | −4.0027E−05 | −2.1178E−05 | 8.7495E−07 | 3.1912E−05 | 1.5557E−05 | 1.1033E−05 | −5.5448E−06 |
| S2 | 3.1029E−05 | −1.2176E−04 | 1.1772E−04 | −9.5918E−05 | 3.3471E−05 | −3.9531E−05 | 8.5320E−06 |
| S3 | −7.5065E−04 | −5.3664E−04 | −7.6661E−05 | −8.1061E−05 | 9.8829E−07 | −1.5562E−05 | −2.2284E−05 |
| S4 | −1.0993E−03 | 7.7841E−04 | −4.5975E−04 | 2.4181E−04 | −1.2071E−04 | 6.8648E−05 | −2.2659E−05 |
| S5 | −5.5926E−04 | 3.7548E−04 | −1.2498E−04 | 5.5663E−05 | 3.2225E−06 | 8.6593E−07 | 1.1648E−05 |
| S6 | −9.3227E−05 | −9.2142E−05 | −2.1239E−05 | −3.6762E−05 | −9.4683E−06 | −7.4638E−06 | −7.6475E−07 |
| S7 | −6.9405E−05 | −3.2028E−05 | −1.0779E−05 | −8.1734E−06 | 0.0000E+00 | 0.0000E+00 | 0.0000E+00 |
| S8 | −1.6755E−05 | −7.0255E−06 | 4.3586E−06 | −2.0823E−06 | 0.0000E+00 | 0.0000E+00 | 0.0000E+00 |
| S9 | −4.0845E−04 | −3.6141E−04 | −1.6070E−04 | −4.0879E−05 | −3.1527E−07 | 0.0000E+00 | 0.0000E+00 |
| S10 | −1.0179E−03 | −8.3175E−04 | −3.7699E−04 | −1.2672E−04 | −5.5696E−06 | −3.3048E−07 | 0.0000E+00 |
| S11 | 1.6441E−03 | −1.3334E−03 | −7.3274E−05 | −7.8026E−05 | 1.8527E−04 | 9.9550E−05 | 1.0665E−05 |
| S12 | 3.9306E−03 | −8.5715E−04 | 1.8507E−04 | 8.6231E−05 | −2.3071E−06 | −2.9947E−04 | −4.3219E−05 |
| S13 | 1.8266E−03 | −4.6096E−03 | −3.5276E−03 | −1.5425E−04 | 8.0850E−04 | 1.7733E−04 | 1.5723E−05 |
| S14 | 6.0368E−03 | 1.2493E−03 | −9.8290E−04 | −1.0357E−03 | −9.4960E−06 | −1.2790E−04 | 4.3378E−05 |

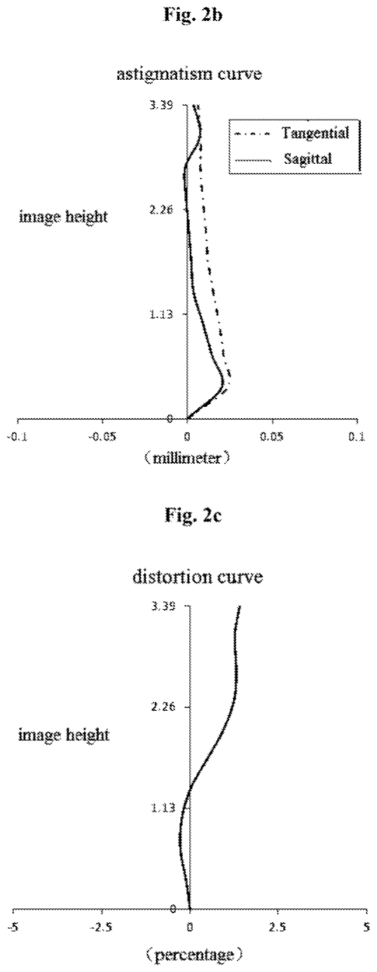

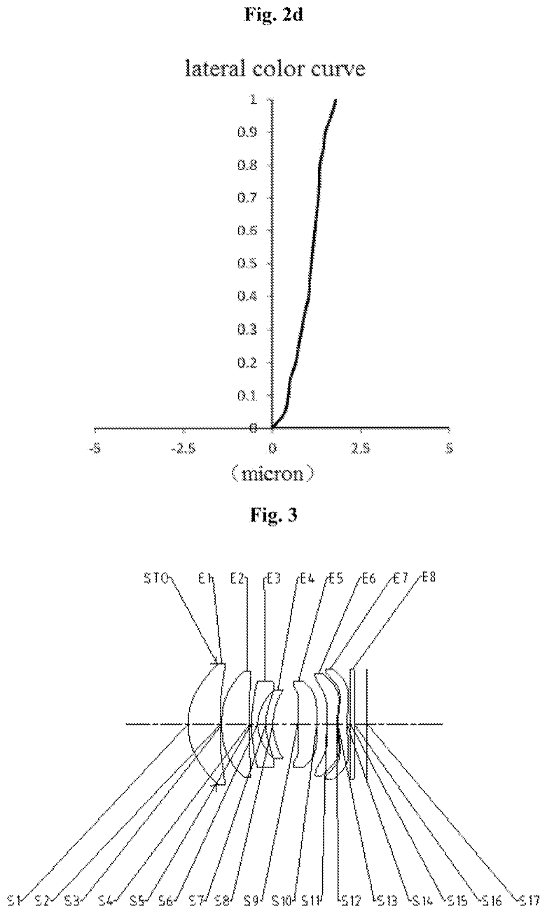

FIG. 2a shows a longitudinal aberration curve of the optical imaging system according to Embodiment 1 to represent deviations of a convergence focal point after lights with different wavelengths pass through the lens. FIG. 2b shows an astigmatism curve of the optical imaging system according to Embodiment 1 to represent a tangential image surface curvature and a sagittal image surface curvature. FIG. 2c shows a distortion curve of the optical imaging system according to Embodiment 1 to represent distortion values corresponding to different image heights. FIG. 2d shows a lateral color curve of the optical imaging system according to Embodiment 1 to represent deviations of different image heights on the imaging surface after the light passes through the lens. According to FIGS. 2a-2d, it can be seen that the optical imaging system provided in Embodiment 1 may achieve high imaging quality.

### Embodiment 2

FIG. 3 shows a structural schematic diagram of a lens group of an optical imaging system according to Embodiment 2 of the disclosure. The optical imaging system sequentially includes from an object side to an image side along an optical axis: a diaphragm STO, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, and an image-side surface S2 thereof is a convex surface. The second lens E2 has a negative refractive power, an object-side surface S3 thereof is a concave surface, and an image-side surface S4 thereof is a convex surface. The third lens E3 has a negative refractive power, an object-side surface S5 thereof is a convex surface, and an image-side surface S6 thereof is a concave surface. The fourth lens E4 has a negative refractive power, an object-side surface S7 thereof is a convex surface, and an image-side surface S8 thereof is a concave surface. The fifth lens E5 has a positive refractive power, an object-side surface S9 thereof is a convex surface, and an image-side surface S10 thereof is a concave surface. The sixth lens E6 has a negative refractive power, an object-side surface S11 thereof is a convex surface, and an image-side surface S12 thereof is a concave surface. The seventh lens E7 has a positive refractive power, an object-side surface S13 thereof is a convex surface, and an image-side surface S14 thereof is a concave surface. The optical filter E8 has an object-side surface S15 and an image-side surface S16. Light from an object sequentially penetrates through each of the surfaces S1 to S16, and is finally imaged on the imaging surface S17.

Table 4 shows a basic parameter table of the optical imaging system of Embodiment 2, wherein units of the curvature radius, the thickness and the focal length are all millimeters (mm).

TABLE 4

| Surface | Surface | Curvature | Thickness/ | Focal | Refractive | Abbe | Conic |
|---|---|---|---|---|---|---|---|
| number | type | radius | distance | length | index | number | coefficient |
| OBJ | Spherical | Infinite | Infinite | | | | |
| STO | Spherical | Infinite | −1.6000 | | | | |
| S1 | Aspheric | 4.2557 | 1.8241 | 4.78 | 1.55 | 56.0 | 0.0000 |
| S2 | Aspheric | −5.7174 | 0.0849 | | | | 0.0000 |
| S3 | Aspheric | −22.0780 | 1.5140 | −70.67 | 1.55 | 56.0 | 0.0000 |
| S4 | Aspheric | −52.9620 | 0.1057 | | | | −17.3373 |
| S5 | Aspheric | 4.6826 | 0.3509 | −5.72 | 1.68 | 19.2 | 0.0000 |
| S6 | Aspheric | 2.0554 | 0.4685 | | | | −1.0000 |
| S7 | Aspheric | 4.2113 | 0.3909 | −67.00 | 1.68 | 19.2 | 0.0000 |
| S8 | Aspheric | 3.7091 | 1.3812 | | | | 0.0000 |
| S9 | Aspheric | 12.6454 | 1.0635 | 19.63 | 1.68 | 19.2 | 0.0000 |
| S10 | Aspheric | 251.4891 | 0.5476 | | | | 0.0000 |
| S11 | Aspheric | 21.5584 | 0.5753 | −21.32 | 1.55 | 56.0 | 0.0000 |
| S12 | Aspheric | 7.4809 | 0.0468 | | | | 0.0000 |
| S13 | Aspheric | 4.1286 | 0.5000 | 576.78 | 1.68 | 19.2 | 0.0000 |
| S14 | Aspheric | 3.9687 | 0.2167 | | | | 0.0000 |
| S15 | Spherical | Infinite | 0.2100 | | 1.52 | 64.2 | |
| S16 | Spherical | Infinite | 0.7198 | | | | |
| S17 | Spherical | Infinite | | | | | |

As shown in Table 5, in Embodiment 2, f is a total effective focal length of the optical imaging system, and f is 8.90 mm. TTL is a distance from the object-side surface S1 of the first lens E1 to the imaging surface S17 on the optical axis, and TTL is 10.00 mm. ImgH is a half of a diagonal length of an effective pixel region on the imaging surface S17, and ImgH is 3.27 mm. Semi-FOV is a half of a maximum field of view of the optical imaging system, and Semi-FOV is 20.1°. Explanations about parameters of each relational expression are the same as those in Embodiment 1. Numerical values of each relational expression are listed in the following Table.

TABLE 5
Embodiment 2

| | | | |
|---|---|---|---|
| f(mm) | 8.90 | TTL(mm) | 10.00 |
| ImgH(mm) | 3.27 | Semi-FOV(°) | 20.1 |
| f/EPD | 1.23 | (f1 + \|R2\|)/f | 1.18 |
| f3/r | −0.64 | f6/R12 | −2.85 |
| \|f4/f5\| | 3.41 | R5/R6 | 2.28 |
| R9/R14 | 3.19 | \|R11/R7\| | 5.12 |
| CT2/CT3 | 4.32 | T45/CT4 | 3.53 |
| 1/(CT3CT6)(mm⁻²) | 4.95 | TTL × Tan(Semi-FOV)(mm) | 3.65 |

In Embodiment 2, both the object-side surface and the image-side surface of any lens in the first lens E1 to the seventh lens E7 are aspheric surfaces. Table 6 shows high-order coefficients A4, A6, A8, A10, A12, A14, A16, A18, A20, A22, A24, A26, A28 and A30 that may be used for each of the aspheric mirror surfaces S1 to S14 in Embodiment 2.

TABLE 6

| Surface | | | | | | | |
|---|---|---|---|---|---|---|---|
| number | A4 | A6 | A8 | A10 | A12 | A14 | A16 |
| S1 | −3.1062E−01 | −8.4847E−02 | −1.4834E−02 | 1.1694E−04 | 7.0861E−04 | 2.4273E−04 | −7.7088E−05 |
| S2 | 1.8344E+00 | −4.5518E−01 | 1.7331E−01 | −6.6319E−02 | 2.9964E−02 | −1.3894E−02 | 6.8138E−03 |
| S3 | 2.0732E+00 | −4.0753E−01 | 1.6938E−01 | −6.6560E−02 | 2.1448E−02 | −1.5568E−02 | 4.9127E−03 |
| S4 | 2.1459E−01 | −6.0134E−02 | 1.6148E−02 | −7.5193E−03 | 4.3023E−04 | −2.5342E−03 | −4.6035E−04 |
| S5 | −5.9182E−01 | 1.1554E−01 | −2.2967E−02 | 6.7710E−03 | 1.7585E−04 | 4.3319E−04 | 3.8324E−04 |
| S6 | −1.8057E−01 | 7.5080E−02 | −3.8586E−03 | 4.8597E−03 | 1.1559E−03 | 6.9275E−04 | −9.5494E−05 |
| S7 | −1.1335E−01 | −1.3995E−02 | 1.1124E−02 | 6.3104E−04 | 4.8921E−05 | 5.9082E−05 | −1.3420E−04 |
| S8 | −6.0824E−02 | 1.0159E−02 | 1.0336E−02 | 2.0741E−03 | 4.3908E−04 | 1.3723E−04 | −3.3303E−05 |
| S9 | −4.6276E−01 | −6.8317E−02 | 5.8398E−04 | 7.7390E−03 | 4.7777E−03 | 1.7847E−03 | 2.6275E−04 |
| S10 | −8.3160E−01 | −1.3735E−02 | 2.0058E−02 | 9.0354E−03 | 5.3130E−03 | 1.3055E−03 | −2.8262E−05 |
| S11 | −1.1195E+00 | 2.4562E−01 | 3.9096E−02 | −3.3255E−02 | 1.0098E−02 | −7.8824E−03 | −1.1775E−03 |
| S12 | −1.5748E+00 | 4.7613E−03 | 9.6097E−02 | −2.2347E−02 | 1.7224E−02 | −5.2766E−03 | 3.9011E−03 |
| S13 | −2.4294E+00 | 1.7519E−01 | 3.0053E−02 | 3.4891E−02 | −8.4093E−03 | 1.9796E−03 | 7.3065E−03 |
| S14 | −2.7410E+00 | 2.0172E−01 | −6.6224E−02 | 5.0731E−02 | −1.3226E−02 | 7.5588E−03 | 6.2290E−03 |
| Surface | | | | | | | |
| number | A18 | A20 | A22 | A24 | A26 | A28 | A30 |
| S1 | −4.8035E−05 | −4.0042E−05 | −7.7150E−06 | −1.4604E−05 | −1.3339E−05 | −1.5230E−05 | −8.6287E−06 |
| S2 | −3.4650E−03 | 1.7263E−03 | −9.4078E−04 | 4.1993E−04 | −2.7034E−04 | 9.1019E−05 | −6.5491E−05 |
| S3 | −3.8067E−03 | 1.1833E−03 | −9.2283E−04 | 4.4309E−04 | −1.1508E−04 | 1.5181E−04 | −2.6565E−05 |
| S4 | −1.3196E−03 | −3.8702E−04 | −5.7494E−04 | −1.5875E−04 | −1.9849E−04 | −4.2054E−05 | −4.0572E−05 |
| S5 | −3.9416E−05 | 4.8609E−05 | −1.1677E−04 | −3.8806E−05 | −7.8723E−05 | −2.9606E−05 | −1.4548E−05 |
| S6 | −9.0615E−05 | −5.4665E−05 | 4.0882E−05 | 7.9130E−05 | 5.8296E−05 | 2.4232E−05 | 4.6782E−06 |
| S7 | −1.2091E−04 | −1.0271E−04 | −5.6090E−05 | −1.5912E−05 | 0.0000E+00 | 0.0000E+00 | 0.0000E+00 |
| S8 | −4.5252E−05 | −4.4385E−05 | −2.9431E−05 | −1.4311E−05 | 0.0000E+00 | 0.0000E+00 | 0.0000E+00 |
| S9 | −2.6841E−04 | −2.6476E−04 | −1.3216E−04 | −3.5912E−05 | −2.6762E−07 | 0.0000E+00 | 0.0000E+00 |
| S10 | −7.3088E−04 | −4.6967E−04 | −2.2532E−04 | −6.1205E−05 | −2.7305E−06 | −1.5982E−07 | 0.0000E+00 |
| S11 | 1.2757E−04 | 1.2517E−03 | 7.5376E−05 | −2.0142E−06 | 1.6805E−04 | 2.5011E−04 | 1.1131E−04 |
| S12 | −2.0364E−03 | 9.8336E−05 | 2.4674E−05 | 3.4092E−04 | −4.5291E−04 | −4.6278E−05 | 3.6839E−05 |
| S13 | −1.2078E−03 | −2.3887E−03 | −1.3728E−03 | −2.2546E−04 | −3.0090E−04 | 2.0024E−04 | 8.6574E−05 |
| S14 | 3.0487E−03 | 4.7389E−04 | 4.2938E−04 | 1.5373E−04 | 2.2427E−04 | 1.6326E−04 | 8.1902E−05 |

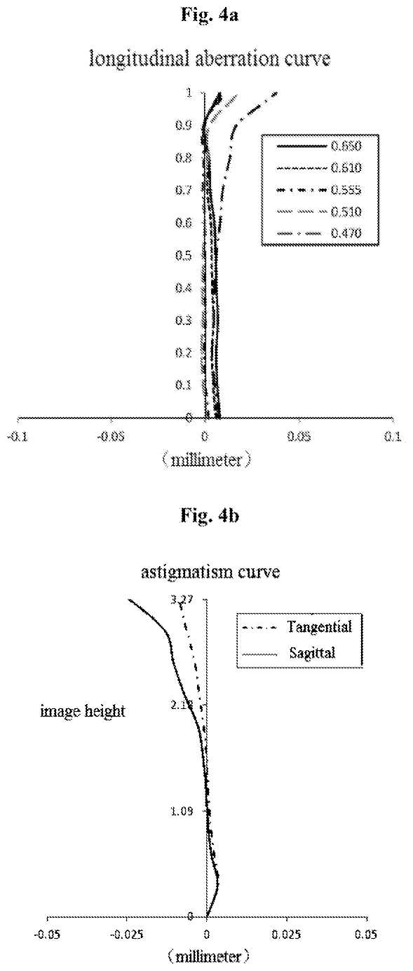

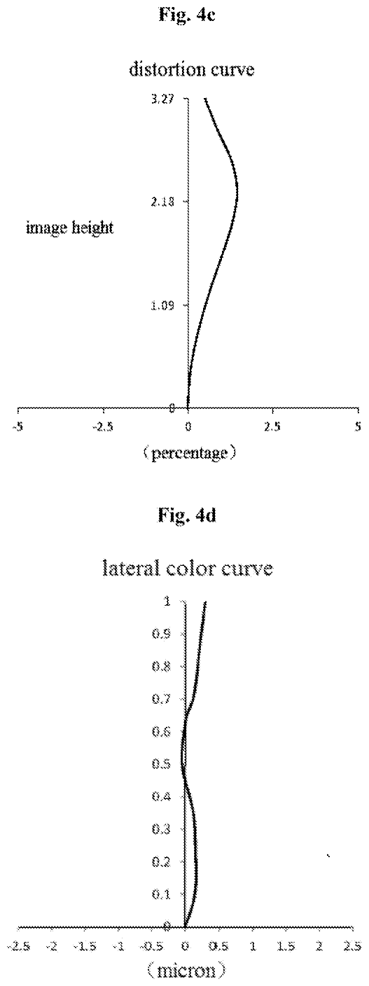

FIG. 4a shows a longitudinal aberration curve of the optical imaging system according to Embodiment 2 to represent deviations of a convergence focal point after lights with different wavelengths pass through the lens. FIG. 4b shows an astigmatism curve of the optical imaging system according to Embodiment 2 to represent a tangential image surface curvature and a sagittal image surface curvature. FIG. 4c shows a distortion curve of the optical imaging system according to Embodiment 2 to represent distortion values corresponding to different image heights. FIG. 4d shows a lateral color curve of the optical imaging system according to Embodiment 2 to represent deviations of different image heights on the imaging surface after the light passes through the lens. According to FIGS. 4a-4d, it can be seen that the optical imaging system provided in Embodiment 2 may achieve high imaging quality.

### Embodiment 3

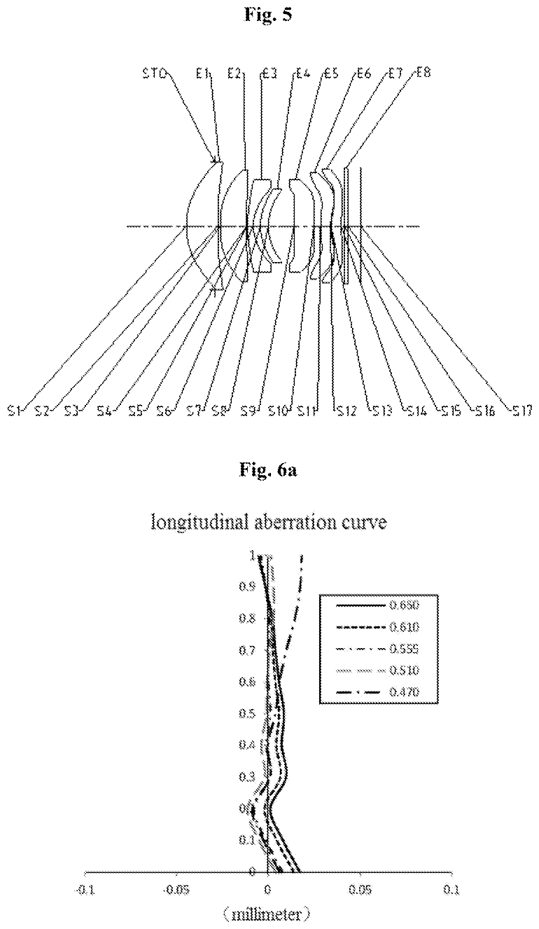

FIG. 5 shows a structural schematic diagram of a lens group of an optical imaging system according to Embodiment 3 of the disclosure. The optical imaging system sequentially includes from an object side to an image side along an optical axis: a diaphragm STO, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, and an image-side surface S2 thereof is a convex surface. The second lens E2 has a positive refractive power, an object-side surface S3 thereof is a convex surface, and an image-side surface S4 thereof is a convex surface. The third lens E3 has a negative refractive power, an object-side surface S5 thereof is a convex surface, and an image-side surface S6 thereof is a concave surface. The fourth lens E4 has a negative refractive power, an object-side surface S7 thereof is a convex surface, and an image-side surface S8 thereof is a concave surface. The fifth lens E5 has a negative refractive power, an object-side surface S9 thereof is a convex surface, and an image-side surface S10 thereof is a concave surface. The sixth lens E6 has a negative refractive power, an object-side surface S11 thereof is a convex surface, and an image-side surface S12 thereof is a concave surface. The seventh lens E7 has a positive refractive power, an object-side surface S13 thereof is a convex surface, and an image-side surface S14 thereof is a concave surface. The optical filter E8 has an object-side surface S15 and an image-side surface S16. Light from an object sequentially penetrates through each of the surfaces S1 to S16, and is finally imaged on the imaging surface S17.

Table 7 shows a basic parameter table of the optical imaging system of Embodiment 3, wherein units of the curvature radius, the thickness and the focal length are all millimeters (mm).

TABLE 7

| Surface | Surface | Curvature | Thickness/ | Focal | Refractive | Abbe | Conic |
|---|---|---|---|---|---|---|---|
| number | type | radius | distance | length | index | number | coefficient |
| OBJ | Spherical | Infinite | Infinite | | | | |
| STO | Spherical | Infinite | −1.6000 | | | | |
| S1 | Aspheric | 4.2480 | 1.8113 | 5.64 | 1.55 | 56.0 | 0.0000 |
| S2 | Aspheric | −9.4431 | 0.1212 | | | | 0.0000 |
| S3 | Aspheric | 39.8100 | 1.4930 | 43.43 | 1.55 | 56.0 | 0.0000 |
| S4 | Aspheric | −57.6421 | 0.0295 | | | | 94.2310 |
| S5 | Aspheric | 4.7327 | 0.3292 | −5.79 | 1.68 | 19.2 | 0.0000 |
| S6 | Aspheric | 2.0843 | 0.4104 | | | | −1.0000 |
| S7 | Aspheric | 3.0170 | 0.4474 | −1480.76 | 1.68 | 19.2 | 0.0000 |
| S8 | Aspheric | 2.8279 | 1.4579 | | | | 0.0000 |
| S9 | Aspheric | 12.7266 | 1.1187 | −168.73 | 1.68 | 19.2 | 0.0000 |
| S10 | Aspheric | 11.0445 | 0.3750 | | | | 0.0000 |
| S11 | Aspheric | 4.6609 | 0.5688 | −5.87 | 1.55 | 56.0 | 0.0000 |
| S12 | Aspheric | 1.8162 | 0.0300 | | | | −1.0000 |
| S13 | Aspheric | 2.0606 | 0.5622 | 5.06 | 1.68 | 19.2 | −1.0000 |
| S14 | Aspheric | 4.6067 | 0.1912 | | | | 0.0000 |
| S15 | Spherical | Infinite | 0.2100 | | 1.52 | 64.2 | |
| S16 | Spherical | Infinite | 0.6944 | | | | |
| S17 | Spherical | Infinite | | | | | |

As shown in Table 8, in Embodiment 3, f is a total effective focal length of the optical imaging system, and f is 8.60 mm. TTL is a distance from the object-side surface S1 of the first lens E1 to the imaging surface S17 on the optical axis, and TTL is 9.85 mm. ImgH is a half of a diagonal length of an effective pixel region on the imaging surface S17, and ImgH is 3.39 mm. Semi-FOV is a half of a maximum field of view of the optical imaging system, and Semi-FOV is 21.1°. Explanations about parameters of each relational expression are the same as those in Embodiment 1. Numerical values of each relational expression are listed in the following Table.

TABLE 8
Embodiment 3

| | | | |
|---|---|---|---|
| f(mm) | 8.60 | TTL(mm) | 9.85 |
| ImgH(mm) | 3.39 | Semi-FOV(°) | 21.1 |
| f/EPD | 1.18 | (f1 + \| R2\|)/f | 1.75 |
| f3/f | −0.67 | f6/R12 | −3.23 |
| \|f4/f5\| | 8.78 | R5/R6 | 2.27 |
| R9/R14 | 2.76 | \|R11/R7\| | 1.54 |
| CT2/CT3 | 4.54 | T45/CT4 | 3.26 |
| 1/(CT3 × CT6)(mm⁻²) | 5.34 | TTL × Tan(Semi-FOV)(mm) | 3.81 |

In Embodiment 3, both the object-side surface and the image-side surface of any lens in the first lens E1 to the seventh lens E7 are aspheric surfaces. Table 9 shows high-order coefficients A4, A6, A8, A10, A12, A14, A16, A18, A20, A22, A24, A26, A28 and A30 that may be used for each of the aspheric mirror surfaces S1 to S14 in Embodiment 3.

TABLE 9

| Surface | | | | | | | |
|---|---|---|---|---|---|---|---|
| number | A4 | A6 | A8 | A10 | A12 | A14 | A16 |
| S1 | −3.2000E−01 | −8.4467E−02 | −1.4337E−02 | 7.6874E−04 | 9.4904E−04 | 2.9367E−04 | −4.9176E−05 |
| S2 | 1.1727E+00 | −3.0871E−01 | 1.1168E−01 | −3.5821E−02 | 1.4624E−02 | −5.8288E−03 | 2.3703E−03 |
| S3 | 1.5190E+00 | −2.6173E−01 | 1.0812E−01 | −3.7390E−02 | 6.4292E−03 | −8.0940E−03 | 1.0955E−03 |
| S4 | 2.0701E−01 | −5.4159E−02 | 1.7617E−02 | −5.8829E−03 | −4.9288E−04 | −2.2258E−03 | −1.6130E−03 |
| S5 | −5.9247E−01 | 1.1359E−01 | −2.2992E−02 | 7.6554E−03 | −6.0824E−04 | 8.9288E−04 | −5.5798E−06 |
| S6 | −1.7275E−01 | 8.4985E−02 | −5.4618E−03 | 5.9405E−03 | 1.3706E−03 | 9.2924E−04 | −8.6419E−05 |
| S7 | −2.0751E−01 | −2.0492E−02 | 8.7041E−03 | 1.2217E−03 | 2.3161E−04 | 5.4412E−06 | −1.2255E−04 |
| S8 | −1.0917E−01 | 1.0073E−02 | 9.1338E−03 | 3.6650E−03 | 1.0784E−03 | 3.6904E−04 | 7.1595E−05 |
| S9 | −4.5378E−01 | −6.7873E−02 | −3.8733E−03 | 7.1949E−03 | 4.9404E−03 | 2.2657E−03 | 6.0624E−04 |
| S10 | −1.1821E+00 | 3.8529E−02 | 1.8561E−02 | 1.1365E−02 | 1.7099E−03 | 6.1877E−04 | −4.4125E−04 |
| S11 | −2.0548E+00 | 4.0372E−01 | −1.1754E−03 | −2.9250E−02 | 6.4278E−03 | −2.7704E−04 | −2.7209E−03 |
| S12 | −3.7699E+00 | 5.5129E−01 | −1.0349E−01 | 7.3825E−02 | −3.9662E−02 | 2.6638E−02 | −1.2693E−02 |
| S13 | −3.4723E+00 | 5.7177E−01 | −1.1675E−01 | 1.2227E−01 | −5.9297E−02 | 2.3324E−02 | −8.2902E−03 |
| S14 | −2.1886E+00 | 1.8211E−01 | −5.4711E−02 | 6.2065E−02 | −1.6911E−02 | 4.7920E−03 | 4.9493E−03 |
| Surface | | | | | | | |
| number | A18 | A20 | A22 | A24 | A26 | A28 | A30 |
| S1 | −1.4431E−04 | −9.4365E−05 | −7.9900E−05 | −3.3358E−05 | −2.8534E−05 | −3.2837E−06 | −8.4142E−06 |
| S2 | −1.2791E−03 | 4.7503E−04 | −3.3219E−04 | 1.0047E−04 | −9.8776E−05 | 1.8784E−05 | −2.3445E−05 |
| S3 | −1.3297E−03 | 4.1465E−04 | −3.3033E−04 | 4.4514E−05 | −1.2335E−04 | 5.3355E−06 | −2.6534E−05 |
| S4 | −1.5698E−03 | −1.3380E−03 | −8.8801E−04 | −5.9708E−04 | −3.2032E−04 | −1.3287E−04 | −5.6143E−05 |
| S5 | 2.4206E−04 | −9.2457E−05 | −8.0615E−06 | −5.7393E−05 | −7.9315E−05 | −3.0113E−05 | −3.3522E−05 |
| S6 | −8.9361E−05 | −1.1102E−04 | 4.2615E−05 | 8.9918E−05 | 4.8494E−05 | 2.1488E−05 | 6.5904E−06 |
| S7 | −1.8455E−04 | −1.3064E−04 | −4.5751E−05 | 9.8888E−06 | 0.0000E+00 | 0.0000E+00 | 0.0000E+00 |
| S8 | −3.4134E−05 | −7.8869E−05 | −6.4185E−05 | −3.0219E−05 | 0.0000E+00 | 0.0000E+00 | 0.0000E+00 |
| S9 | −4.3844E−05 | −1.4371E−04 | −8.5555E−05 | −3.1025E−05 | −2.6386E−07 | 0.0000E+00 | 0.0000E+00 |
| S10 | −4.6160E−04 | −1.4582E−04 | −8.9756E−05 | −4.0542E−05 | −1.4524E−06 | −6.4504E−08 | 0.0000E+00 |
| S11 | 4.8675E−04 | −1.0660E−04 | 1.0511E−04 | 1.8665E−04 | 3.8782E−04 | 1.2425E−05 | 6.3137E−05 |
| S12 | 9.6021E−03 | −7.2855E−03 | 4.8000E−03 | −2.3263E−03 | 1.5594E−03 | −1.0566E−03 | 2.1376E−04 |
| S13 | 8.0137E−03 | −7.8783E−03 | 4.5033E−03 | −2.6148E−03 | 1.1486E−03 | −1.3747E−03 | 4.2988E−04 |
| S14 | 1.5998E−03 | −2.4870E−04 | 1.5777E−03 | 3.8224E−04 | 4.4611E−04 | −1.7828E−05 | 1.9436E−04 |

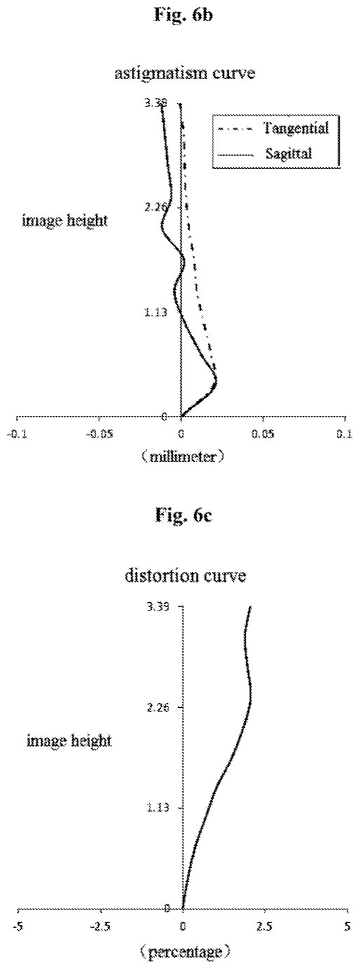

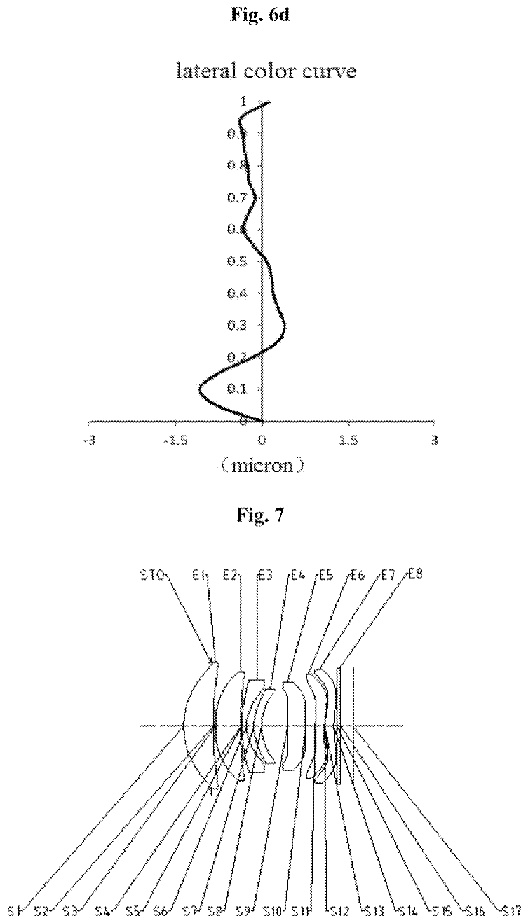

FIG. 6a shows a longitudinal aberration curve of the optical imaging system according to Embodiment 3 to represent deviations of a convergence focal point after lights with different wavelengths pass through the lens. FIG. 6b shows an astigmatism curve of the optical imaging system according to Embodiment 3 to represent a tangential image surface curvature and a sagittal image surface curvature. FIG. 6c shows a distortion curve of the optical imaging system according to Embodiment 3 to represent distortion values corresponding to different image heights. FIG. 6d shows a lateral color curve of the optical imaging system according to Embodiment 3 to represent deviations of different image heights on the imaging surface after the light passes through the lens. According to FIGS. 6a-6d, it can be seen that the optical imaging system provided in Embodiment 3 may achieve high imaging quality.

### Embodiment 4

FIG. 7 shows a structural schematic diagram of a lens group of an optical imaging system according to Embodiment 4 of the disclosure. The optical imaging system sequentially includes from an object side to an image side along an optical axis: a diaphragm STO, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, and an image-side surface S2 thereof is a convex surface. The second lens E2 has a positive refractive power, an object-side surface S3 thereof is a convex surface, and an image-side surface S4 thereof is a concave surface. The third lens E3 has a negative refractive power, an object-side surface S5 thereof is a convex surface, and an image-side surface S6 thereof is a concave surface. The fourth lens E4 has a negative refractive power, an object-side surface S7 thereof is a convex surface, and an image-side surface S8 thereof is a concave surface. The fifth lens E5 has a positive refractive power, an object-side surface S9 thereof is a convex surface, and an image-side surface S10 thereof is a concave surface. The sixth lens E6 has a negative refractive power, an object-side surface S11 thereof is a convex surface, and an image-side surface S12 thereof is a concave surface. The seventh lens E7 has a positive refractive power, an object-side surface S13 thereof is a convex surface, and an image-side surface S14 thereof is a concave surface. The optical filter E8 has an object-side surface S15 and an image-side surface S16. Light from an object sequentially penetrates through each of the surfaces S1 to S16, and is finally imaged on the imaging surface S17.

Table 10 shows a basic parameter table of the optical imaging system of Embodiment 4, wherein units of the curvature radius, the thickness and the focal length are all millimeters (mm).

TABLE 10

| Surface | Surface | Curvature | Thickness/ | Focal | Refractive | Abbe | Conic |
|---|---|---|---|---|---|---|---|
| number | type | radius | distance | length | index | number | coefficient |
| OBJ | Spherical | Infinite | Infinite | | | | |
| STO | Spherical | Infinite | −1.6160 | | | | |
| S1 | Aspheric | 4.2711 | 1.7495 | 5.75 | 1.55 | 56.0 | 0.0000 |
| S2 | Aspheric | −10.1018 | 0.1089 | | | | 0.0000 |
| S3 | Aspheric | 23.6839 | 1.4617 | 57.72 | 1.55 | 56.0 | 0.0000 |
| S4 | Aspheric | 93.6780 | 0.0200 | | | | 73.5262 |
| S5 | Aspheric | 4.4725 | 0.3001 | −6.47 | 1.68 | 19.2 | 0.0000 |
| S6 | Aspheric | 2.1537 | 0.4226 | | | | −1.0000 |
| S7 | Aspheric | 2.9365 | 0.4359 | −99.23 | 1.68 | 19.2 | 0.0000 |
| S8 | Aspheric | 2.6449 | 1.5209 | | | | 0.0000 |
| S9 | Aspheric | 14.6784 | 1.0450 | 36.15 | 1.68 | 19.2 | 0.0000 |
| S10 | Aspheric | 35.6322 | 0.5426 | | | | 0.0000 |
| S11 | Aspheric | 8.2264 | 0.5351 | −4.49 | 1.55 | 56.0 | 0.0000 |
| S12 | Aspheric | 1.8437 | 0.0300 | | | | −1.0000 |
| S13 | Aspheric | 1.7083 | 0.5102 | 4.68 | 1.68 | 19.2 | −1.0000 |
| S14 | Aspheric | 3.2611 | 0.2022 | | | | −1.0000 |
| S15 | Spherical | Infinite | 0.2121 | | 1.52 | 64.2 | |
| S16 | Spherical | Infinite | 0.7032 | | | | |
| S17 | Spherical | Infinite | | | | | |

As shown in Table 11, in Embodiment 4, f is a total effective focal length of the optical imaging system, and f is 8.64 mm. TTL is a distance from the object-side surface S1 of the first lens E1 to the imaging surface S17 on the optical axis, and TTL is 9.80 mm. ImgH is a half of a diagonal length of an effective pixel region on the imaging surface S17, and ImgH is 3.39 mm. Semi-FOV is a half of a maximum field of view of the optical imaging system, and Semi-FOV is 21.2°. Explanations about parameters of each relational expression are the same as those in Embodiment 1. Numerical values of each relational expression are listed in the following Table.

TABLE 11
Embodiment 4

| | | | |
|---|---|---|---|
| f(mm) | 8.64 | TTL(mm) | 9.80 |
| ImgH(mm) | 3.39 | Semi-FOV(°) | 21.2 |
| f/EPD | 1.18 | (f1 + \|R2\|)/f | 1.84 |
| f3/f | −0.75 | f6/R12 | −2.44 |
| \|f4/f5\| | 2.75 | R5/R6 | 2.08 |
| R9/R14 | 4.50 | \|R11/R7\| | 2.80 |
| CT2/CT3 | 4.87 | T45/CT4 | 3.49 |
| 1/(CT3 × CT6)(mm⁻²) | 6.23 | TTL × Tan(Semi-FOV)(mm) | 3.79 |

In Embodiment 4, both the object-side surface and the image-side surface of any lens in the first lens E1 to the seventh lens E7 are aspheric surfaces. Table 12 shows high-order coefficients A4, A6, A8, A10, A12, A14, A16, A18, A20, A22, A24, A26, A28 and A30 that may be used for each of the aspheric mirror surfaces S1 to S14 in Embodiment 4.

TABLE 12

| Surface | | | | | | | |
|---|---|---|---|---|---|---|---|
| number | A4 | A6 | A8 | A10 | A12 | A14 | A16 |
| S1 | −3.3639E−01 | −8.7926E−02 | −1.5841E−02 | 9.1472E−04 | 1.1005E−03 | 4.7083E−04 | −4.5551E−06 |
| S2 | 1.1862E+00 | −3.2033E−01 | 1.1613E−01 | −3.7785E−02 | 1.6209E−02 | −6.3463E−03 | 2.7018E−03 |
| S3 | 1.5034E+00 | −2.3310E−01 | 1.0063E−01 | −3.3885E−02 | 5.3816E−03 | −8.1797E−03 | 6.1448E−04 |
| S4 | 1.9114E−01 | −5.1203E−02 | 1.7626E−02 | −4.7535E−03 | 2.0787E−04 | −1.8118E−03 | −2.2784E−03 |
| S5 | −5.9535E−01 | 1.0073E−01 | −1.9531E−02 | 6.5404E−03 | 4.8720E−05 | 8.7673E−04 | 2.3551E−04 |
| S6 | −1.2648E−01 | 8.6318E−02 | −3.1596E−03 | 6.6613E−03 | 1.8539E−03 | 8.2778E−04 | 1.3936E−04 |
| S7 | −3.0412E−01 | −1.2763E−02 | 7.8853E−03 | 1.0071E−03 | −3.5138E−04 | −3.8839E−04 | −1.0006E−04 |
| S8 | −1.9392E−01 | 9.3405E−03 | 8.4584E−03 | 3.3331E−03 | 1.0586E−03 | 3.6313E−04 | 1.3807E−04 |
| S9 | −4.6172E−01 | −7.2801E−02 | −5.8781E−03 | 5.8887E−03 | 4.8247E−03 | 2.4993E−03 | 1.0259E−03 |
| S10 | −1.0230E+00 | 6.3093E−03 | 2.0937E−02 | 1.2279E−02 | 3.5753E−03 | 9.5404E−05 | −5.5922E−04 |
| S11 | −1.4657E+00 | 3.2858E−01 | 8.1058E−03 | −3.5670E−02 | 1.2876E−02 | −3.5552E−03 | −4.6997E−04 |
| S12 | −3.9339E+00 | 6.4077E−01 | −1.5536E−01 | 9.7099E−02 | −5.0888E−02 | 3.7005E−02 | −2.1198E−02 |
| S13 | −4.3024E+00 | 7.6686E−01 | −1.9249E−01 | 1.5654E−01 | −7.6498E−02 | 3.9391E−02 | −1.9647E−02 |
| S14 | −2.6590E+00 | 3.0849E−01 | −8.2557E−02 | 7.1322E−02 | −2.5457E−02 | 1.1838E−02 | 1.1954E−03 |
| Surface | | | | | | | |
| number | A18 | A20 | A22 | A24 | A26 | A28 | A30 |
| S1 | −1.5973E−04 | −1.3315E−04 | −1.1422E−04 | −6.1264E−05 | −4.3140E−05 | −2.1309E−05 | −1.5900E−05 |
| S2 | −1.4913E−03 | 5.6317E−04 | −4.2381E−04 | 1.3187E−04 | −1.3458E−04 | 2.6250E−05 | −3.1726E−05 |
| S3 | −1.1738E−03 | 6.2231E−04 | −1.8894E−04 | 3.4285E−05 | −2.1197E−04 | −7.7725E−05 | −5.1248E−05 |
| S4 | −2.5447E−03 | −2.1768E−03 | −1.1019E−03 | −5.9819E−04 | −1.7105E−04 | −9.7772E−05 | −1.8715E−05 |
| S5 | 2.3922E−04 | −1.5353E−04 | −5.5219E−05 | −1.2344E−04 | −7.1304E−05 | −3.2436E−05 | −3.0175E−05 |
| S6 | −1.0632E−04 | −1.7230E−04 | −3.2895E−05 | 4.6716E−05 | 6.4636E−05 | 5.7434E−05 | 2.2214E−05 |
| S7 | −2.8358E−05 | 1.9121E−06 | 6.2413E−06 | 1.2441E−05 | 0.0000E+00 | 0.0000E+00 | 0.0000E+00 |
| S8 | 4.3410E−05 | 5.7921E−06 | −5.9181E−06 | −3.7359E−06 | 0.0000E+00 | 0.0000E+00 | 0.0000E+00 |
| S9 | 2.8213E−04 | 3.5444E−05 | −2.0084E−05 | −1.2298E−05 | −1.1378E−07 | 0.0000E+00 | 0.0000E+00 |
| S10 | −5.9921E−04 | −2.9344E−04 | −1.0636E−04 | −5.2688E−05 | −2.6268E−06 | −1.7805E−07 | 0.0000E+00 |
| S11 | −3.0760E−04 | −1.6132E−04 | 3.4298E−04 | 2.5772E−05 | 2.2250E−04 | 5.7532E−05 | 5.9399E−05 |
| S12 | 1.4885E−02 | −1.0733E−02 | 6.6499E−03 | −3.6031E−03 | 2.3143E−03 | −1.2461E−03 | 3.8704E−04 |
| S13 | 1.3345E−02 | −1.1240E−02 | 6.4399E−03 | −3.6511E−03 | 1.9837E−03 | −1.7805E−03 | 3.6322E−04 |
| S14 | 3.0197E−03 | −7.2107E−04 | 1.3690E−03 | 1.1353E−04 | 8.0106E−04 | 5.5025E−05 | 5.0875E−05 |

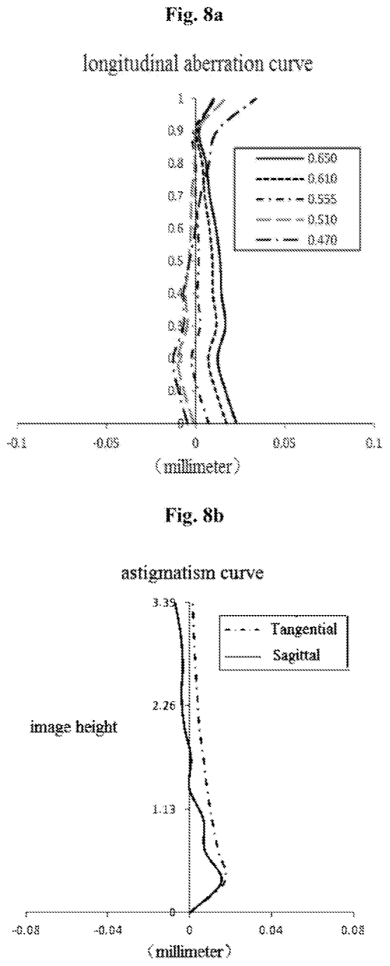

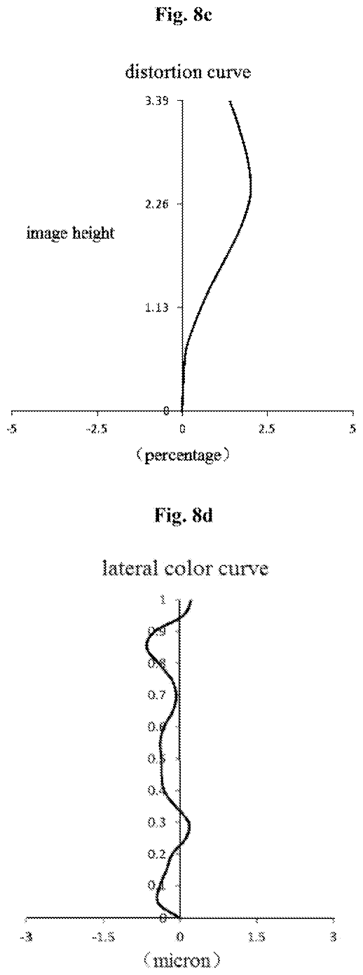

FIG. 8a shows a longitudinal aberration curve of the optical imaging system according to Embodiment 4 to represent deviations of a convergence focal point after lights with different wavelengths pass through the lens. FIG. 8b shows an astigmatism curve of the optical imaging system according to Embodiment 4 to represent a tangential image surface curvature and a sagittal image surface curvature. FIG. 8c shows a distortion curve of the optical imaging system according to Embodiment 4 to represent distortion values corresponding to different image heights. FIG. 8d shows a lateral color curve of the optical imaging system according to Embodiment 4 to represent deviations of different image heights on the imaging surface after the light passes through the lens. According to FIGS. 8a-8d, it can be seen that the optical imaging system provided in Embodiment 4 may achieve high imaging quality.

### Embodiment 5

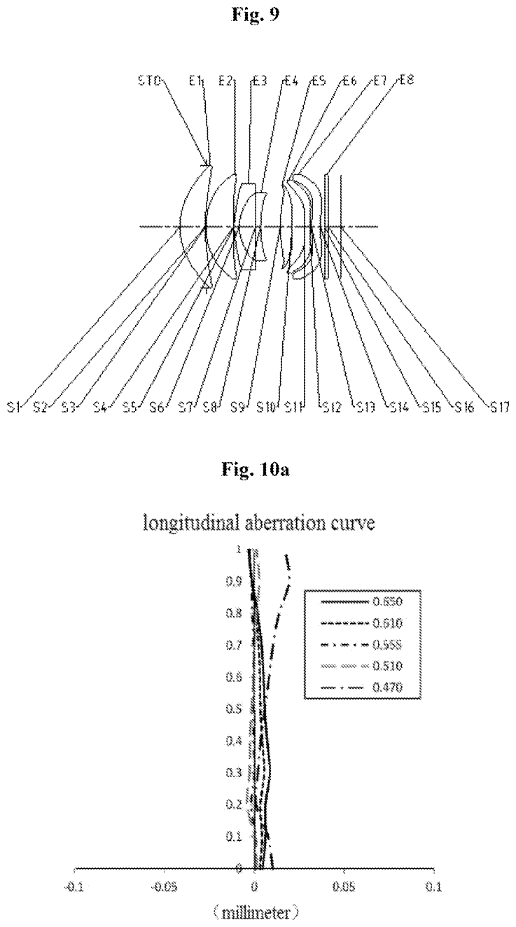

FIG. 9 shows a structural schematic diagram of a lens group of an optical imaging system according to Embodiment 5 of the disclosure. The optical imaging system sequentially includes from an object side to an image side along an optical axis: a diaphragm STO, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, and an image-side surface S2 thereof is a concave surface. The second lens E2 has a positive refractive power, an object-side surface S3 thereof is a convex surface, and an image-side surface S4 thereof is a convex surface. The third lens E3 has a negative refractive power, an object-side surface S5 thereof is a convex surface, and an image-side surface S6 thereof is a concave surface. The fourth lens E4 has a negative refractive power, an object-side surface S7 thereof is a convex surface, and an image-side surface S8 thereof is a concave surface. The fifth lens E5 has a positive refractive power, an object-side surface S9 thereof is a convex surface, and an image-side surface S10 thereof is a convex surface. The sixth lens E6 has a negative refractive power, an object-side surface S11 thereof is a convex surface, and an image-side surface S12 thereof is a concave surface. The seventh lens E7 has a positive refractive power, an object-side surface S13 thereof is a convex surface, and an image-side surface S14 thereof is a concave surface. The optical filter E8 has an object-side surface S15 and an image-side surface S16. Light from an object sequentially penetrates through each of the surfaces S1 to S16, and is finally imaged on the imaging surface S17.

Table 13 shows a basic parameter table of the optical imaging system of Embodiment 5, wherein units of the curvature radius, the thickness and the focal length are all millimeters (mm).

TABLE 13

| Surface | Surface | Curvature | Thickness/ | Focal | Refractive | Abbe | Conic |
|---|---|---|---|---|---|---|---|
| number | type | radius | distance | length | index | number | coefficient |
| OBJ | Spherical | Infinite | Infinite | | | | |
| STO | Spherical | Infinite | −1.6000 | | | | |
| S1 | Aspheric | 4.0880 | 1.5050 | 9.84 | 1.55 | 56.0 | 0.0000 |
| S2 | Aspheric | 14.9696 | 0.0300 | | | | 0.0000 |
| S3 | Aspheric | 4.5176 | 1.6193 | 8.26 | 1.55 | 56.0 | 0.0000 |
| S4 | Aspheric | −1078.1640 | 0.0517 | | | | −99.0000 |
| S5 | Aspheric | 4.4651 | 0.3000 | −6.51 | 1.68 | 19.2 | 0.0000 |
| S6 | Aspheric | 2.1572 | 0.9521 | | | | 0.0000 |
| S7 | Aspheric | 11.5247 | 0.3000 | −12.33 | 1.68 | 19.2 | 0.0000 |
| S8 | Aspheric | 4.7903 | 1.1734 | | | | 0.0000 |
| S9 | Aspheric | 6.9555 | 0.7000 | 9.35 | 1.68 | 19.2 | 0.0000 |
| S10 | Aspheric | −67.0975 | 0.7352 | | | | 0.0000 |
| S11 | Aspheric | 35.1237 | 0.3059 | −12.63 | 1.55 | 56.0 | 0.0000 |
| S12 | Aspheric | 5.7398 | 0.0984 | | | | 0.0000 |
| S13 | Aspheric | 4.6063 | 0.5217 | 1999.97 | 1.68 | 19.2 | 0.0000 |
| S14 | Aspheric | 4.4107 | 0.2570 | | | | 0.0000 |
| S15 | Spherical | Infinite | 0.2100 | | 1.52 | 64.2 | |
| S16 | Spherical | Infinite | 0.7602 | | | | |
| S17 | Spherical | Infinite | | | | | |

As shown in Table 14, in Embodiment 5, f is a total effective focal length of the optical imaging system, and f is 8.90 mm. TTL is a distance from the object-side surface S1 of the first lens E1 to the imaging surface S17 on the optical axis, and TTL is 9.52 mm. ImgH is a half of a diagonal length of an effective pixel region on the imaging surface S17, and ImgH is 3.10 mm. Semi-FOV is a half of a maximum field of view of the optical imaging system, and Semi-FOV is 18.9°. Explanations about parameters of each relational expression are the same as those in Embodiment 1. Numerical values of each relational expression are listed in the following Table.

TABLE 14
Embodiment 5

| | | | |
|---|---|---|---|
| f(mm) | 8.90 | TTL(mm) | 9.52 |
| ImgH(mm) | 3.10 | Semi-FOV(°) | 18.9 |
| f/EPD | 1.23 | (f1 + \|R2\|)/f | 2.79 |
| f3/f | −0.73 | f6/R12 | −2.20 |
| \|f4/f5\| | 1.32 | R5/R6 | 2.07 |
| R9/R14 | 1.58 | \|R11/R7\| | 3.05 |
| CT2/CT3 | 5.40 | T45/CT4 | 3.91 |
| 1/(CT3 × CT6)(mm⁻²) | 10.90 | TTL × Tan(Semi-FOV)(mm) | 3.26 |

In Embodiment 5, both the object-side surface and the image-side surface of any lens in the first lens E1 to the seventh lens E7 are aspheric surfaces. Table 15 shows high-order coefficients A4, A6, A8, A10, A12, A14, A16, A18, A20, A22, A24, A26, A28 and A30 that may be used for each of the aspheric mirror surfaces S1 to S14 in Embodiment 5.

TABLE 15

| Surface | | | | | | | |
|---|---|---|---|---|---|---|---|
| number | A4 | A6 | A8 | A10 | A12 | A14 | A16 |
| S1 | −3.4957E−01 | −7.8351E−02 | −1.2646E−02 | −1.1536E−03 | 7.3756E−05 | 2.3919E−04 | 1.8020E−04 |
| S2 | −3.0061E−02 | −2.9036E−02 | 1.5144E−02 | −4.0118E−03 | 3.4013E−03 | −7.7981E−04 | 6.6883E−04 |
| S3 | 3.4903E−01 | 3.0885E−02 | 1.1560E−02 | −8.2955E−03 | −1.6561E−03 | −2.4290E−03 | −8.6547E−04 |
| S4 | 2.2572E−01 | −4.6507E−02 | 8.2223E−03 | −7.3369E−03 | 3.4360E−03 | −2.9743E−03 | 1.3173E−03 |
| S5 | −4.3436E−01 | 9.0157E−02 | −5.9761E−03 | −2.1883E−03 | 2.3692E−03 | −1.8340E−03 | 1.0935E−03 |
| S6 | −3.9476E−01 | 9.3008E−03 | −2.0035E−03 | 1.4978E−04 | 6.5199E−04 | −2.5157E−05 | 5.3312E−05 |
| S7 | −1.8034E−01 | 1.9008E−02 | 3.3644E−03 | −1.7003E−04 | 3.2000E−05 | −1.1065E−05 | 3.7569E−07 |
| S8 | −1.1951E−01 | 3.3666E−02 | 3.6643E−03 | −3.1020E−04 | −8.3950E−05 | −6.5334E−05 | −1.5596E−05 |
| S9 | −3.4206E−01 | −6.4066E−02 | −7.3228E−04 | 5.6756E−03 | 3.9721E−03 | 1.3685E−03 | 1.6580E−05 |
| S10 | −5.2825E−01 | −3.1280E−02 | 1.4976E−02 | 1.4259E−02 | 7.6041E−03 | 2.0813E−03 | −4.2447E−04 |
| S11 | −1.5069E+00 | 3.0684E−01 | 2.4248E−02 | −2.2182E−02 | 1.0776E−03 | −7.9924E−03 | 1.7966E−03 |
| S12 | −2.1324E+00 | 1.1712E−01 | −1.9477E−05 | −1.7426E−02 | 6.5649E−03 | 2.5757E−03 | 4.1735E−03 |
| S13 | −2.4294E+00 | 4.0450E−02 | 1.2380E−02 | 6.0288E−02 | 1.0222E−02 | 1.5519E−02 | 8.1961E−04 |
| S14 | −2.9719E+00 | 1.1106E−01 | −4.1873E−02 | 6.0983E−02 | 6.5645E−04 | 1.5199E−02 | 5.4955E−04 |
| Surface | | | | | | | |
| number | A18 | A20 | A22 | A24 | A26 | A28 | A30 |
| S1 | 8.5802E−05 | 3.0934E−05 | 9.0963E−06 | −8.8584E−07 | −9.3828E−06 | −9.3276E−06 | −8.7452E−06 |
| S2 | −3.1756E−04 | 1.1511E−04 | −1.1079E−04 | −2.0704E−05 | −3.4423E−05 | −2.2494E−05 | −6.9619E−06 |
| S3 | −9.7693E−04 | −5.0515E−04 | −3.5546E−04 | −1.9530E−04 | −9.6971E−05 | −3.8018E−05 | −1.6881E−05 |
| S4 | −9.2342E−04 | 4.9069E−04 | −2.7917E−04 | 1.6032E−04 | −7.0644E−05 | 3.0006E−05 | −1.3676E−05 |
| S5 | −3.8755E−04 | 2.8660E−04 | −4.5334E−05 | 6.7617E−05 | 2.4695E−05 | 1.1396E−05 | 1.0346E−05 |
| S6 | 1.0060E−05 | −8.8579E−06 | 8.7024E−06 | −3.7144E−06 | 7.3720E−07 | −3.3914E−07 | −2.2092E−07 |
| S7 | −9.3671E−07 | 2.2073E−06 | −1.0436E−06 | −8.0100E−08 | 0.0000E+00 | 0.0000E+00 | 0.0000E+00 |
| S8 | −4.9544E−06 | 1.7100E−06 | −4.7576E−07 | 5.0114E−08 | 0.0000E+00 | 0.0000E+00 | 0.0000E+00 |
| S9 | −2.8513E−04 | −9.7069E−05 | 7.5566E−06 | 1.3695E−05 | 4.7370E−08 | 0.0000E+00 | 0.0000E+00 |
| S10 | −1.0367E−03 | −5.6188E−04 | −1.7415E−04 | −3.0360E−05 | −4.7795E−07 | 8.9362E−09 | 0.0000E+00 |
| S11 | 6.8446E−04 | −1.1998E−04 | −5.4901E−04 | −2.9601E−04 | 4.5524E−04 | 4.3187E−04 | 1.7666E−04 |
| S12 | 1.8155E−03 | 6.6139E−05 | 9.6918E−04 | −6.3605E−04 | −2.8881E−04 | −1.9071E−04 | −1.1723E−05 |
| S13 | −2.3359E−03 | −3.0082E−03 | 6.8483E−04 | 4.5123E−05 | −3.3954E−04 | −5.2731E−04 | −2.6370E−04 |
| S14 | −4.8106E−04 | −1.2856E−04 | 1.3239E−03 | 4.7105E−04 | −1.1734E−04 | −3.6184E−04 | −1.6301E−04 |

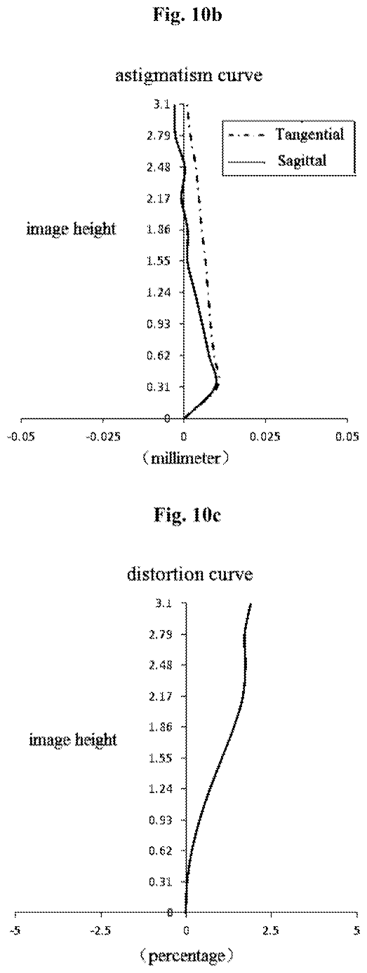

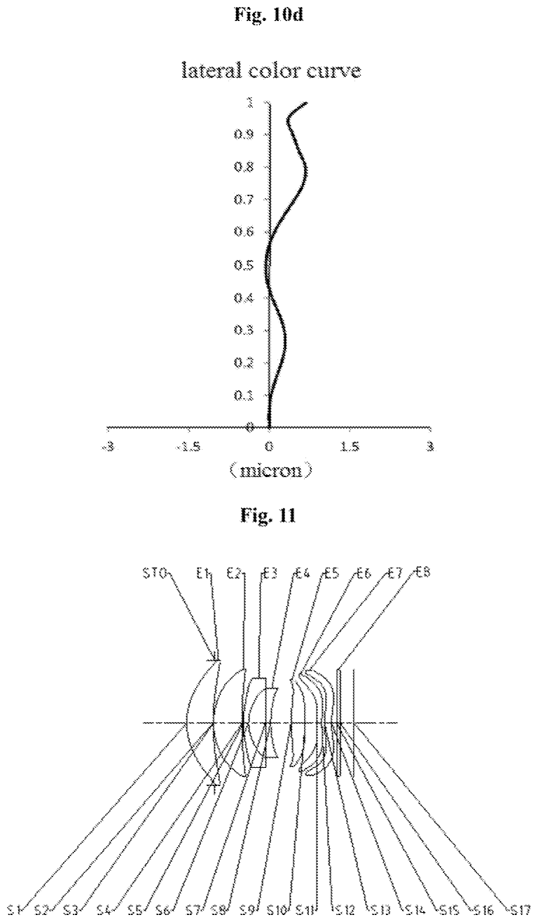

FIG. 10a shows a longitudinal aberration curve of the optical imaging system according to Embodiment 5 to represent deviations of a convergence focal point after lights with different wavelengths pass through the lens. FIG. 10b shows an astigmatism curve of the optical imaging system according to Embodiment 5 to represent a tangential image surface curvature and a sagittal image surface curvature. FIG. 10c shows a distortion curve of the optical imaging system according to Embodiment 5 to represent distortion values corresponding to different image heights. FIG. 10d shows a lateral color curve of the optical imaging system according to Embodiment 5 to represent deviations of different image heights on the imaging surface after the light passes through the lens. According to FIGS. 10a-10d, it can be seen that the optical imaging system provided in Embodiment 5 may achieve high imaging quality.

### Embodiment 6

FIG. 11 shows a structural schematic diagram of a lens group of an optical imaging system according to Embodiment 6 of the disclosure. The optical imaging system sequentially includes from an object side to an image side along an optical axis: a diaphragm STO, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, and an image-side surface S2 thereof is a concave surface. The second lens E2 has a positive refractive power, an object-side surface S3 thereof is a convex surface, and an image-side surface S4 thereof is a convex surface. The third lens E3 has a negative refractive power, an object-side surface S5 thereof is a convex surface, and an image-side surface S6 thereof is a concave surface. The fourth lens E4 has a negative refractive power, an object-side surface S7 thereof is a convex surface, and an image-side surface S8 thereof is a concave surface. The fifth lens E5 has a positive refractive power, an object-side surface S9 thereof is a convex surface, and an image-side surface S10 thereof is a convex surface. The sixth lens E6 has a negative refractive power, an object-side surface S11 thereof is a concave surface, and an image-side surface S12 thereof is a concave surface. The seventh lens E7 has a positive refractive power, an object-side surface S13 thereof is a convex surface, and an image-side surface S14 thereof is a concave surface. The optical filter E8 has an object-side surface S15 and an image-side surface S16. Light from an object sequentially penetrates through each of the surfaces S1 to S16, and is finally imaged on the imaging surface S17.

Table 16 shows a basic parameter table of the optical imaging system of Embodiment 6, wherein units of the curvature radius, the thickness and the focal length are all millimeters (mm).

TABLE 16

| Surface | Surface | Curvature | Thickness/ | Focal | Refractive | Abbe | Conic |
|---|---|---|---|---|---|---|---|
| number | type | radius | distance | length | index | number | coefficient |
| OBJ | Spherical | Infinite | Infinite | | | | |
| STO | Spherical | Infinite | −1.6000 | | | | |
| S1 | Aspheric | 4.0736 | 1.4977 | 10.11 | 1.55 | 56.0 | 0.0000 |
| S2 | Aspheric | 13.5892 | 0.0300 | | | | 0.0000 |
| S3 | Aspheric | 4.4115 | 1.6279 | 8.01 | 1.55 | 56.0 | 0.0000 |
| S4 | Aspheric | −397.4394 | 0.0505 | | | | 99.0000 |
| S5 | Aspheric | 4.3940 | 0.3000 | −6.41 | 1.68 | 19.2 | 0.0000 |
| S6 | Aspheric | 2.1226 | 0.9554 | | | | 0.0000 |
| S7 | Aspheric | 10.0946 | 0.3000 | −12.98 | 1.68 | 19.2 | 0.0000 |
| S8 | Aspheric | 4.6408 | 1.1659 | | | | 0.0000 |
| S9 | Aspheric | 8.9492 | 0.8015 | 9.04 | 1.68 | 19.2 | 0.0000 |
| S10 | Aspheric | −18.6699 | 0.6862 | | | | 0.0000 |
| S11 | Aspheric | −26.1965 | 0.2471 | −12.17 | 1.55 | 56.0 | 0.0000 |
| S12 | Aspheric | 8.9169 | 0.1470 | | | | 0.0000 |
| S13 | Aspheric | 3.1959 | 0.4054 | 1989.12 | 1.68 | 19.2 | 0.0000 |
| S14 | Aspheric | 3.0395 | 0.2862 | | | | −1.0000 |
| S15 | Spherical | Infinite | 0.2100 | | 1.52 | 64.2 | |
| S16 | Spherical | Infinite | 0.7894 | | | | |
| S17 | Spherical | Infinite | | | | | |

As shown in Table 17, in Embodiment 6, f is a total effective focal length of the optical imaging system, and f is 8.90 mm. TTL is a distance from the object-side surface S1 of the first lens E1 to the imaging surface S17 on the optical axis, and TTL is 9.50 mm. ImgH is a half of a diagonal length of an effective pixel region on the imaging surface S17, and ImgH is 3.10 mm. Semi-FOV is a half of a maximum field of view of the optical imaging system, and Semi-FOV is 18.9°. Explanations about parameters of each relational expression are the same as those in Embodiment 1. Numerical values of each relational expression are listed in the following Table.

TABLE 17
Embodiment 6

| | | | |
|---|---|---|---|
| f(mm) | 8.90 | TTL(mm) | 9.50 |
| ImgH(mm) | 3.10 | Semi-FOV(°) | 18.9 |
| f/EPD | 1.23 | (f1 + \| R2\|)/f | 2.66 |
| f3/f | −0.72 | f6/R12 | −1.37 |
| \|f4/f5\| | 1.44 | R5/R6 | 2.07 |
| R9/R14 | 2.94 | \|R11/R7\| | 2.60 |
| CT2/CT3 | 5.43 | T45/CT4 | 3.89 |
| 1/(CT3 × CT6)(mm⁻²) | 13.49 | TTL × Tan(Semi-FOV)(mm) | 3.25 |

In Embodiment 6, both the object-side surface and the image-side surface of any lens in the first lens E1 to the seventh lens E7 are aspheric surfaces. Table 18 shows high-order coefficients A4, A6, A8, A10, A12, A14, A16, A18, A20, A22, A24, A26, A28 and A30 that may be used for each of the aspheric mirror surfaces S1 to S14 in Embodiment 6.

TABLE 18

| Surface | | | | | | | |
|---|---|---|---|---|---|---|---|
| number | A4 | A6 | A8 | A10 | A12 | A14 | A16 |
| S1 | −3.5961E−01 | −8.1402E−02 | −1.3073E−02 | −1.2751E−03 | 8.6965E−05 | 2.2984E−04 | 1.5229E−04 |
| S2 | −7.1699E−02 | −1.6813E−02 | 1.0978E−02 | −2.5925E−03 | 2.8252E−03 | −6.1347E−04 | 4.9960E−04 |
| S3 | 3.0279E−01 | 3.9688E−02 | 9.4422E−03 | −7.6981E−03 | −2.0708E−03 | −2.5102E−03 | −1.1016E−03 |
| S4 | 2.3127E−01 | −4.9076E−02 | 9.1967E−03 | −7.9394E−03 | 3.4780E−03 | −3.0661E−03 | 1.3835E−03 |
| S5 | −4.5445E−01 | 9.2923E−02 | −7.2589E−03 | −1.4248E−03 | 2.2487E−03 | −1.6485E−03 | 1.0877E−03 |
| S6 | −4.0544E−01 | 9.1688E−03 | −3.5162E−03 | −3.0417E−05 | 3.7282E−04 | −8.2420E−05 | 1.5148E−05 |
| S7 | −1.6926E−01 | 1.9258E−02 | 3.1657E−03 | −1.9618E−04 | −5.8311E−06 | −2.4090E−05 | 1.6412E−06 |
| S8 | −1.0788E−01 | 3.7259E−02 | 3.3633E−03 | −7.1081E−04 | −2.6240E−04 | −1.1939E−04 | −2.1684E−05 |
| S9 | −4.1837E−01 | −6.4197E−02 | 3.0551E−03 | 5.7096E−03 | 2.7820E−03 | 6.4880E−04 | 8.6548E−05 |
| S10 | −5.1059E−01 | −1.8487E−02 | 1.8599E−02 | 1.2362E−02 | 5.8318E−03 | 1.0041E−03 | −3.1642E−04 |
| S11 | −1.2270E+00 | 2.4355E−01 | 5.2989E−02 | −3.3324E−02 | 2.5901E−03 | −1.0787E−02 | 4.0121E−03 |
| S12 | −2.0361E+00 | 4.6886E−02 | 1.9753E−02 | −2.1741E−02 | 9.9835E−03 | 2.6636E−04 | 4.5161E−03 |
| S13 | −3.3464E+00 | 8.3799E−02 | −3.8103E−02 | 6.8234E−02 | 1.6507E−03 | 1.4559E−02 | −5.0194E−03 |
| S14 | −3.3680E+00 | 2.4442E−01 | −7.4804E−02 | 8.2743E−02 | 9.4565E−04 | 1.6407E−02 | −4.9064E−03 |
| Surface | | | | | | | |
| number | A18 | A20 | A22 | A24 | A26 | A28 | A30 |
| S1 | 6.5889E−05 | 2.5246E−05 | 6.7568E−06 | 2.4757E−06 | −8.7268E−06 | −8.9283E−06 | −9.4198E−06 |
| S2 | −2.1039E−04 | 5.2567E−05 | −6.2777E−05 | −4.1170E−05 | −2.4468E−05 | −2.5621E−05 | −4.3984E−06 |
| S3 | −9.2175E−04 | −4.9868E−04 | −2.9036E−04 | −1.6489E−04 | −7.8808E−05 | −3.1183E−05 | −1.6003E−05 |
| S4 | −9.4613E−04 | 4.7601E−04 | −2.8015E−04 | 1.4869E−04 | −7.0332E−05 | 2.4560E−05 | −1.5047E−05 |
| S5 | −4.0161E−04 | 2.5110E−04 | −5.6151E−05 | 5.1354E−05 | 1.8455E−05 | 7.0658E−06 | 6.0838E−06 |
| S6 | 4.5976E−06 | −1.3724E−05 | 7.7838E−06 | −2.2503E−06 | 7.8533E−07 | −9.9995E−07 | −2.2588E−08 |
| S7 | −1.5999E−06 | 2.4056E−06 | −2.5761E−06 | 2.6411E−07 | 0.0000E+00 | 0.0000E+00 | 0.0000E+00 |
| S8 | −5.1745E−06 | 2.8109E−06 | −1.4751E−06 | 4.7334E−07 | 0.0000E+00 | 0.0000E+00 | 0.0000E+00 |
| S9 | 6.1486E−05 | 1.0910E−04 | 5.3561E−05 | 7.6984E−06 | 4.2354E−08 | 0.0000E+00 | 0.0000E+00 |
| S10 | −5.4548E−04 | −2.4640E−04 | −6.7856E−05 | −2.3066E−05 | −4.9581E−07 | 5.2118E−10 | 0.0000E+00 |
| S11 | 6.2445E−04 | −1.8908E−04 | −1.6290E−04 | −1.0751E−04 | 4.2303E−04 | 1.8196E−04 | 1.0460E−04 |
| S12 | 1.9650E−03 | −6.0533E−04 | 7.8157E−04 | −9.4688E−04 | 9.9299E−05 | −1.6323E−04 | 2.1645E−04 |
| S13 | −2.2619E−03 | −2.9370E−03 | 1.8620E−03 | 6.9609E−04 | −2.6088E−05 | −7.1277E−04 | −3.1362E−04 |
| S14 | −1.4980E−03 | −1.0917E−03 | 2.3140E−03 | 1.0662E−03 | 2.6136E−04 | −3.9502E−04 | −1.7528E−04 |

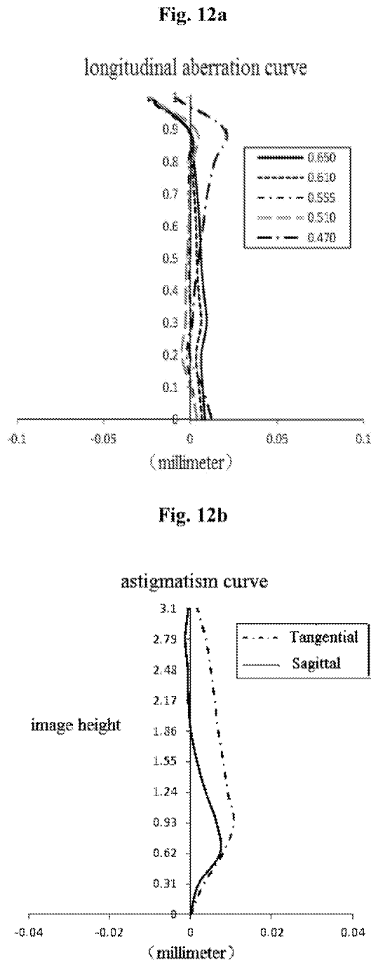

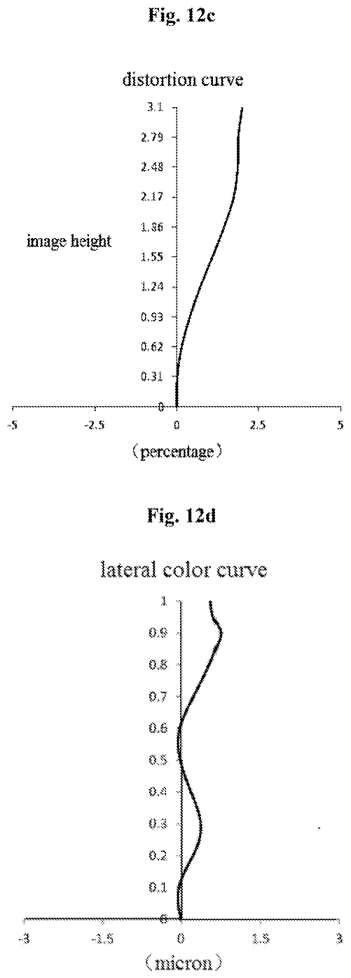

FIG. 12a shows a longitudinal aberration curve of the optical imaging system according to Embodiment 6 to represent deviations of a convergence focal point after lights with different wavelengths pass through the lens. FIG. 12b shows an astigmatism curve of the optical imaging system according to Embodiment 6 to represent a tangential image surface curvature and a sagittal image surface curvature. FIG. 12c shows a distortion curve of the optical imaging system according to Embodiment 6 to represent distortion values corresponding to different image heights. FIG. 12d shows a lateral color curve of the optical imaging system according to Embodiment 6 to represent deviations of different image heights on the imaging surface after the light passes through the lens. According to FIGS. 12a-12d, it can be seen that the optical imaging system provided in Embodiment 6 may achieve high imaging quality.

The above are only specific embodiments of the disclosure and are not intended to limit the disclosure. Any modifications, improvements, equivalent replacements and the like made within the spirit and principle of the disclosure shall fall within the scope of protection of the disclosure.

What is claimed is:

1. An optical imaging system, sequentially comprising from an object side to an image side along an optical axis:
a diaphragm;
a first lens with a positive refractive power;
a second lens with a refractive power;
a third lens with a refractive power;
a fourth lens with a refractive power;
a fifth lens with a refractive power;
a sixth lens with a refractive power, an object-side surface thereof is a convex surface or a concave surface; and
a seventh lens with a positive refractive power,
wherein an effective focal length f of the optical imaging system and an entrance pupil diameter (EPD) of the optical imaging system satisfy: f/EPD<1.3.

2. The optical imaging system according to claim 1, wherein an effective focal length f1 of the first lens, a curvature radius R2 of an image-side surface of the first lens and the effective focal length f of the optical imaging system f satisfy: 1.0<(f1+|R2|)/f<3.0.

3. The optical imaging system according to claim 1, wherein an effective focal length f3 of the third lens and the effective focal length f of the optical imaging system satisfy: −1.0<f3/f<0.

4. The optical imaging system according to claim 1, wherein an effective focal length f6 of the sixth lens and a curvature radius R12 of an image-side surface of the sixth lens satisfy: −5.0<f6/R12<−1.0.

5. The optical imaging system according to in claim 1, wherein an effective focal length f4 of the fourth lens and an effective focal length f5 of the fifth lens satisfy: 0<|f4/f5|<9.0.

6. The optical imaging system according to claim 1, wherein a curvature radius R5 of an object-side surface of the third lens and a curvature radius R6 of an image-side surface of the third lens satisfy: 1.0<R5/R6<2.5.

7. The optical imaging system according to claim 1, wherein a curvature radius R9 of an object-side surface of the fifth lens and a curvature radius R14 of an image-side surface of the seventh lens satisfy: 1.0<R9/R14<5.0.

8. The optical imaging system according to claim 1, wherein a curvature radius R11 of the object-side surface of the sixth lens and a curvature radius R7 of an object-side surface of the fourth lens satisfy: 1.0<|R11/R7|<5.5.

9. The optical imaging system according to claim 1, wherein a center thickness CT2 of the second lens on the optical axis and a center thickness CT3 of the third lens on the optical axis satisfy: 4.0<CT2/CT3<7.5.

10. The optical imaging system according to claim 1, wherein T45 is an air space between the fourth lens and the fifth lens on the optical axis, and T45 and a center thickness CT4 of the fourth lens on the optical axis satisfy: 3.0<T45/CT4<8.0.

11. The optical imaging system according to claim 1, wherein a center thickness CT3 of the third lens on the optical axis and a center thickness CT6 of the sixth lens on the optical axis satisfy: 4.5 mm⁻²<1/(CT3×CT6)<13.5 mm⁻².

12. The optical imaging system according to claim 1, wherein TTL is an on-axis distance from an object-side surface of the first lens to an imaging surface, Semi-FOV is a half of a maximum field of view of the optical imaging system, and TTL and Semi-FOV satisfy: 3.0 mm<TTL×Tan(Semi-FOV)<4.0 mm.

13. The optical imaging system according to claim 1, wherein a refractive index N7 of the seventh lens satisfies: N7>1.6.

14. An optical imaging system, sequentially comprising from an object side to an image side along an optical axis:
a diaphragm;
a first lens with a positive refractive power;
a second lens with a refractive power;
a third lens with a refractive power;
a fourth lens with a refractive power;
a fifth lens with a refractive power;
a sixth lens with a refractive power, an object-side surface thereof is a convex surface or a concave surface; and
a seventh lens with a positive refractive power,
wherein TTL is an on-axis distance from an object-side surface of the first lens to an imaging surface, Semi-FOV is a half of a maximum field of view of the optical imaging system, and TTL and Semi-FOV satisfy: 3.0 mm<TTL×Tan(Semi-FOV)<4.0 mm.

15. The optical imaging system according to claim 14, wherein an effective focal length f of the optical imaging system and an entrance pupil diameter (EPD) of the optical imaging system satisfy: f/EPD<1.3.

16. The optical imaging system according to claim 14, wherein an effective focal length f1 of the first lens, a curvature radius R2 of an image-side surface of the first lens and the effective focal length f of the optical imaging system f satisfy: 1.0<(f1+|R2|)/f<3.0.

17. The optical imaging system according to claim 14, wherein an effective focal length f3 of the third lens and the effective focal length f of the optical imaging system satisfy: −1.0<f3/f<0.

18. The optical imaging system according to claim 14, wherein an effective focal length f6 of the sixth lens and a curvature radius R12 of an image-side surface of the sixth lens satisfy: −5.0<f6/R12<−1.0.

19. The optical imaging system according to claim 14, wherein an effective focal length f4 of the fourth lens and an effective focal length f5 of the fifth lens satisfy: 0<|f4/f5|<9.0.

20. The optical imaging system according to claim 14, wherein a curvature radius R5 of an object-side surface of the third lens and a curvature radius R6 of an image-side surface of the third lens satisfy: 1.0<R5/R6<2.5.
